(19) United States
(12) Patent Application Publication
(10) Pub. No.: US 2020/0272625 A1
(43) Pub. Date: Aug. 27, 2020

(54) PLATFORM AND METHOD FOR EVALUATING, EXPLORING, MONITORING AND PREDICTING THE STATUS OF REGIONS OF THE PLANET THROUGH TIME

(71) Applicant: National Geographic Society, Washington, DC (US)

(72) Inventors: Steven P. BRUMBY, Washington, DC (US); Fabien LAURIER, Glenleg, MD (US); Samantha B. HYDE, Washington, DC (US); Karl Daniel KLAUSSEN, Arlington, VA (US)

(73) Assignee: National Geographic Society, Washington, DC (US)

(21) Appl. No.: 16/797,284

(22) Filed: Feb. 21, 2020

Related U.S. Application Data
(60) Provisional application No. 62/809,098, filed on Feb. 22, 2019.

(51) Int. Cl. G06F 16/2458; G06N 20/00; G06N 5/04; G06F 16/22; G06F 16/26; G06F 16/2457; G06F 16/248

(52) U.S. Cl. CPC G06F 16/2474; G06N 20/00; G06N 5/04; G06F 16/248; G06F 16/26; G06F 16/24573; G06F 16/2228

(57) ABSTRACT

A Platform and Method for Evaluating, Exploring, and Predicting the Status of Regions of the Planet through Time is provided. The method is a computer-implemented means for evaluating an area. The method includes collecting relevant datasets, transforming datasets into dynamic datasets, selecting a region of interest, selecting factors of interest, producing an evaluation index for the region of interest, specifying targets and thresholds for the evaluation index, generating a visualization of the evaluation index for the region of interest; generating alerts when the evaluation index changes in specified ways, and reporting the status and trend of the region of interest using the evaluation index. The data transformation is optionally achieved with machine learning algorithms and training data to produce time series indices. The method may also produce predictive models and maps from the time series indices.

### CROSS-REFERENCE TO RELATED APPLICATIONS

This application claims priority from U.S. Provisional Patent Application No. 62/809,098, filed on Feb. 22, 2019, entitled “A PLATFORM AND METHOD FOR EVALUATING, EXPLORING, AND PREDICTING THE STATUS OF REGIONS OF THE PLANET THROUGH TIME,” the entire contents of which are hereby incorporated by reference.

### BACKGROUND

Planet Earth is a constantly changing system with a high level of complexity. This makes finding reliable and consistent aids for evaluating, exploring, monitoring and predicting a region of the planet, or comparing different regions, both vital and extremely difficult. Data can be collected on a wide range of science-based factors but need to be transformed to actionable knowledge that can be readily updated and customized for specific use cases.

These challenges are particularly felt in policy making and financial decision making with regard to regions of the planet. Decision makers require tools to manage natural resources, ensure provision of ecosystem services, conserve biological diversity, mitigate climate change and the risks of natural disasters such as coastal flooding, and preserve cultural heritage sites. Decision makers confront an abundance of separate datasets, signals, and models focusing on different pieces of the picture as they attempt to make decisions. Billions of dollars are spent each year on conservation actions, but there are no consistent data-driven baselines or metrics to assess the success or failure of conservation efforts or prioritize new areas for investment.

Traditionally, decision making tools have been extremely limited in how they can reconcile data sets with one another and formulate conclusions subject to many constraints. Such analysis has usually required expensive and slow manual analysis of data sets, or analysis of just a few aspects of the picture rather than the picture as a whole.

When data analysis is conducted according to these conventional, manual methods, it can often be out of date as soon as it is completed, or immediately invalidated by being based on assumptions that no longer hold true, such as data that has historically been assumed to be static or constrained to a certain range, but which no longer falls within those parameters.

Rapid advances in technological innovation have now enabled the collection, storage, and processing of unprecedented amounts of data and information about our planet, including a variety of environmental datasets based on satellite observations of the Earth. The availability of high-capacity networks, low-cost computers and data storage have fueled the exponential growth in cloud computing and geospatial analytical capabilities. New automated methods and algorithms have reduced the technical skills needed by users to make decisions based on these datasets, opening up the data for increased use by policy makers in government, finance and industry.

The result of this growth in environmental data has been as much of a challenge in this field as in every field that makes extensive use of “big data.” Experts often describe “big data” challenges based on the “three Vs,” volume, velocity, and variety. The volume of data collected can present issues for many organizations because of the hardware requirements that may be necessary to physically store and process this data. The velocity of data can present issues because data must be processed as quickly as it comes in, or else a backlog is created that creates even more problems with data volume. Finally, the variety of data can present issues since data may be provided in many different formats from many different sources, such as text, images, sound, and video, all provided in numerous different file types, most of which must be handled differently. (For example, some sources may be more or less reliable than others and may be subject to further screening to ensure data reliability.)

As such, despite the ever-increasing need for speedy analysis, the speed with which conventional data models can generate a result can often be slowed further by the “big data” issues associated with data collection.

What all this means is that, despite the scientific and technological advances in collecting Earth observation data, natural systems remain poorly measured and managed, and conventional modeling methods are increasingly inadequate to deal with these problems.

To briefly discuss these conventional modeling methods, it may be noted that there are several existing geospatial visualization and global data analytical platforms attempting to coordinate, compute, and display environmental data. However, none have effectively packaged and communicated Earth's information in a way that key decision-makers can consume and act upon without requiring a high level of scientific training and technical skill. Consequently, most of the high-value datasets about Earth's systems are underused, rather than transformed to actionable insights.

Examples of attempts to achieve these goals can be seen in prior patent documents including U.S. Patent Application Publication Number 2016/020314.6 A1 for Ecosystem Services Index, Exchange and Marketplace and Methods of Using Same, and U.S. Pat. No. 9,928,319 B1 for Flexible Framework for Ecological Niche Modeling, and U.S. Patent Application Publication Number 2018/0173820 A1 for Inferring Ecological Niche Model Input Layers. These tools have attempted to break down various aspects of the global system (or some other relevant system) into pieces, or represent aspects of the full system, but cannot fully evaluate the system with a singular representation and predict its future status in totality.

Some other tools have been developed to provide global access to databases of metrics on land, forest change, biodiversity, land use, and climate conditions. Some of these programs visualize the data on maps for selected areas or provide the collected data and some sort of analytical summary with selected statistics. These tools are likewise inadequate to meet the above goals.

One example of the tools discussed above is Global Forest Watch (GFW), produced by the University of Maryland, World Resources Institute and other science partners. Per its own description, GFW “offers the latest data, technology and tools that empower people everywhere to better protect forests.” GFW provides a map interface where a user can zoom in to different locations based on data representations on the map, a dashboard where a user can select different regions by name, and various alert and subscription options for new available data and information about a region or area. These features used in combination allow users to access a significant amount of data organized in a geographic manner, and GFW also allows users to subscribe for updates on different data areas or regions manageable on their account. However, while GFW may allow users to access a significant amount of information through collected databases and summary statistics, this tool falls short of sufficiently enabling effective, efficient and informed decision making in a number of ways, and as such is inadequate to meet the policy analysis goals discussed above.

First, Global Forest Watch is tightly focused on problem of deforestation, and fails to provide representations of the environmental health and trend of the region of interest with respect to non-forest resources, biodiversity, marine areas or human infrastructure.

Second, Global Forest Watch fails to incorporate a means for predicting the impact of a potential decision to facilitate the practical application of the decision-making process. While there are a number of available resources that can separately show past and present aspects of the globe that may help a policymaker to identify a problem, no present interfaces exist that can usefully combine a current representation with the impact of an action of interest, such as to designate a region of interest for protection, restoration or increased regulation/management.

Third, Global Forest Watch organizes information based on political regions, and so is not well-suited to analysis of regions as a whole, based on hydrology or ecological zones, and can only provide alerts for individual occurrences of data points on specific factors, rather than when the region as a whole experiences a significant change.

Without these features, the present options are insufficient for the ultimate practical purposes of evaluating, exploring, and predicting the status of regions of the planet.

### SUMMARY

The present application provides for a Platform and Method for Evaluating, Exploring, Monitoring and Predicting the Status of Regions of the Planet through Time. A Platform and Method for Evaluating, Exploring, and Predicting the Status of Regions of the Planet through Time is provided. The method is a computer-implemented means for evaluating an area. The method includes collecting relevant datasets, transforming datasets into dynamic datasets, selecting a region of interest, selecting factors of interest, producing an evaluation index for the region of interest, specifying targets and thresholds for the evaluation index, generating a visualization of the evaluation index for the region of interest; generating alerts when the evaluation index changes in specified ways, and reporting the status and trend of the region of interest using the evaluation index. The data transformation is optionally achieved with machine learning algorithms and training data to produce time series indices. The method may also produce predictive models and maps from the time series indices.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a method for evaluating, exploring, and predicting the status of regions of the planet through time.

FIG. 2 is an exemplary embodiment of a system for evaluating, exploring, and predicting the status of regions of the planet through time.

FIG. 3 is an exemplary embodiment of a method for evaluating, exploring, and predicting the status of regions of the planet through time.

FIG. 4 is an exemplary embodiment of a method for evaluating, exploring, and predicting the status of regions of the planet through time with selected factor(s) of interest.

FIG. 5 is an exemplary embodiment of a method for evaluating, exploring, and predicting the status of regions of the planet through time with artificially intelligent factor selection.

FIG. 6 is an exemplary embodiment of a method for evaluating, exploring, and predicting the status of regions of the planet through time including selected alert(s) of interest.

FIG. 7 is an exemplary embodiment of a method for evaluating, exploring, and predicting the status of regions of the planet through time including an artificially intelligent alert selection.

FIG. 8 is an exemplary embodiment of a method for evaluating, exploring, and predicting the status of regions of the planet through time with action(s) of interest.

FIG. 9 is an exemplary embodiment of a method for evaluating, exploring, and predicting the status of regions of the planet through time with an artificially intelligent index action selection.

FIG. 10 is an exemplary user interface for a platform and method for evaluating, exploring, and predicting the status of regions of the planet through time.

FIG. 11 is an exemplary user interface for selecting a region of interest.

FIG. 12 is an exemplary user interface for selecting a region of interest.

FIG. 13 is an exemplary user interface for a platform and method for evaluating, exploring, and predicting the status of regions of the planet through time with a region of interest and an index.

FIG. 14 is an exemplary user interface for a platform and method for evaluating, exploring, and predicting the status of regions of the planet through time with selected factors of interest.

FIG. 15 is an exemplary user interface for a platform and method for evaluating, exploring, and predicting the status of regions of the planet through time with options for related regions of interest.

FIG. 16 is an exemplary user interface for a platform and method for evaluating, exploring, and predicting the status of regions of the planet through time.

FIG. 17 is an exemplary user interface for a platform and method for evaluating, exploring, and predicting the status of regions of the planet through time.

FIG. 18 is a diagram depicting an exemplary embodiment of a training process for an AI system.

FIG. 19 is an exemplary hierarchical taxonomy for land use and land cover which may be employed in an exemplary embodiment of a training process.

FIG. 20 is an exemplary embodiment of a map depicting a sample set of biomes.

FIG. 21 is an exemplary embodiment of a map depicting a sample set of biomes, in this case showing a plurality of exemplary sample points.

FIG. 22 is an exemplary embodiment of a map depicting an exemplary interface for annotating training data.

FIG. 23 is an exemplary embodiment of a set of biome images taken directly from mapping data.

FIG. 24 is an exemplary embodiment of a set of biome images that have been annotated by human markup.

FIG. 25 is an exemplary diagram presenting a comparison between exemplary embodiments of mapping data, mapping data reviewed by an expert markup process, and mapping data reviewed by a workforce markup process.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a platform and method for evaluating, exploring, and predicting the status of regions of the planet may be disclosed.

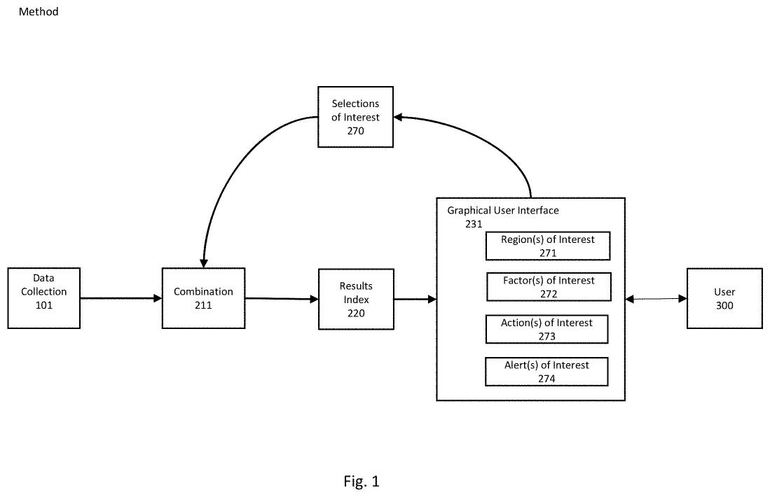

Turning now to exemplary FIG. 1, FIG. 1 displays an exemplary embodiment of a method for evaluating, exploring, and predicting the status of regions of the planet through time. The method may include data collection 101, data combination 211, a results index 220, and provision of the data on a graphical user interface 231 on which selections of interest 270 may be made, which may include region(s) of interest 271, factor(s) of interest 272, action(s) of interest 273, and alert(s) of interest 274, all of which may be interacted with by a user 300.

Data collection 101 may include the collection of one or more datasets and the storage of these datasets in a datastore 100. Such datasets are maintained in the datastore 100 persistently and may be stored compressed or uncompressed as, for example, raw data, derived, processed, or calculated data, or encoded or encrypted data.

The datastore may be indexed to allow for faster or more efficient data retrieval by the platform 200. Such indexing may occur through conventional means known in the art or through machine learning algorithms that may optimize data indexing and readiness through usage characteristics such as frequency of data recall, usage in indexing calculations, popularity of datasets, reliability of datasets, or a confidence metric of the datasets.

Access to the datastore and datasets within it may be constrained by user identity to specify and protect the privacy of individual datasets (e.g., Datasets containing non-public information on land ownership within a country, or locations under consideration for investment by an NGO). User ability to manipulate the datastore and datasets within it may be controlled by specifying a user role, such as viewer, editor, or administrator. Access to the datastore by all users may be logged to enable tracking of user and administrator access patterns. Access to the datastore by all users may use encryption and multi-factor authentication to verify identity and secure user interactions with the datastore and datasets within it.

Datasets may be regularly updated, and as such, it is preferable that each dataset be associated with a reference time marker or information. Datasets may be submitted to the datastore 100 in a bulk or complete form, and datasets may be actively submitted—submitted “live”—to the datastore 100. Data may be updated periodically, such as daily, weekly, monthly, bi-monthly, yearly, etc.

Updating a dataset does not necessarily involve overwriting “old” data with “new” data. While such an overwrite may be desirable to correct datasets which were submitted erroneously or submitted with errors, it may also be desirable to preserve data received in the datastore 100 at various reference times for the construction of time series even though “newer” data may be available. Redundant datasets, or datasets with information which may overlap positionally and/or temporally are also preferably stored redundantly to increase the robustness of indices generation, time series generation, and the like.

The datasets may be collected by satellite observation, observations by human field works, remote sensors, and any other means of data collection. Remote sensors may include camera traps, acoustic sensors, thermal sensors, radio collars, or other animal and environmental monitoring devices.

The datasets may include global reference points. Global reference points may be discrete points or representative of a region, sub-region, or grouping of discrete points.

Datasets may include data from the entire globe as well as data from various regions, sub-regions, or collections thereof. For example, a dataset may be composed of data from all of Africa, data from only the protected wildlife areas of Africa, data from a specific protected wildlife area of Africa, data from a specific sensor location of a specific wildlife area of Africa, and/or any combination thereof.

The datasets may include data layers where each global reference point contains at least one piece of data. These global reference points may also be referenced to as pixels, each pixel likewise containing at least one piece of data. Data layers may be produced using a dynamic land map algorithm, which may specifically be configured to make use of a land use land cover (LULC) map.

For reference, LULC maps provide a label at each location, e.g., “forest”, “grassland”, “wetland”, “agriculture,” “settlement” or “desert”. A dynamic land map generalizes a LULC map by adding time, revealing how the land changes through time, e.g., forest to grasslands to agriculture or settlements over months or years. In an embodiment of the system, it may be contemplated for dynamic land maps to be created using automated processing as soon as new inputs are available. For example, ESA Sentinel-2 satellite data may be used to provide a new scene for any given location every 4 days, enabling a new global map to be produced continuously, with all previous timesteps retained.

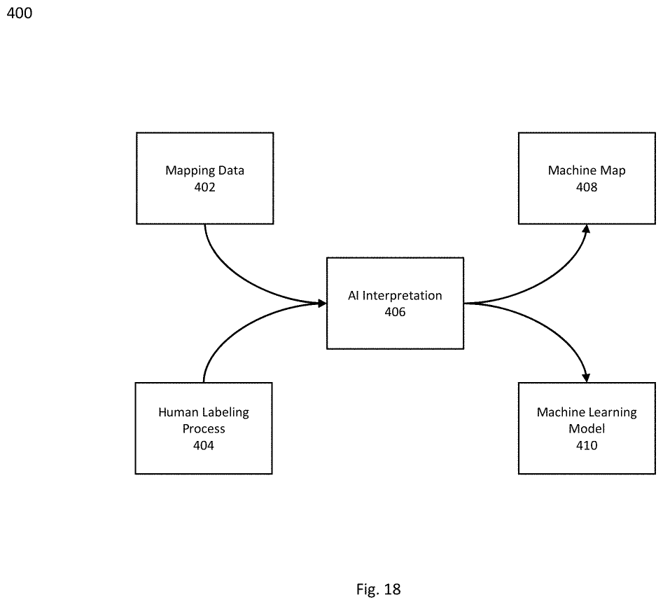

In an exemplary embodiment, dynamic land maps may be generated via large scale application of computer vision algorithms to recent global satellite imagery. Dynamic land maps are created using deep learning algorithms trained on large datasets. For example, in one exemplary embodiment, human-generated training data may be provided to the computer vision algorithms at gigapixel size, i.e. >1 billion human-generated pixel labels. These deep learning algorithms, which may also be referred to as deep structured learning or differential programming, preferably utilize a supervised or semi-supervised training regime to train a final model which is then used for the processing of new data to be incorporated into the dynamic land maps. This training process may be described in more detail in FIGS. 18-25.

Preferably, a given map may be human-tagged with the appropriate land use labels (e.g., “forest”, “grassland”, “settlement”) to create a training map. Other variations may likewise be contemplated; for example, it may be contemplated to have the training process incorporate an initial automated tagging step and a human review and revision step, if desired, particularly as the training process develops. It may likewise be contemplated for the system to incorporate one or more existing land use and/or land cover maps, or one or more other existing maps (such as other remote sensing maps or conceptual maps like political maps) into the overall data. In such an exemplary embodiment, a training map may then be broken down into its constituent pixels, with all relevant data points for that given pixel made available to the training algorithm.

It may generally be contemplated that, in making use of sets of land use or land cover maps, a principal issue that may be presented is that each land use or land cover survey may define similarly-named categories in different ways. For example, at the simplest level, it may be contemplated for a first map to differentiate between “residential” and “non-residential” urban areas or developed spaces, while a second map provides “informal residential,” “formal residential,” and “non-residential” areas, resulting in many of the “residential” areas of the second map being classified as a “formal residential” or “informal residential” area in the first map. This can make it somewhat impractical to combine the two maps. This may likewise be the case for any other type of land cover, as well; for example, the definition of what constitutes a “forest,” or a “natural forest” versus a “plantation forest,” may not be consistent from organization to organization, and any differentiation may be reliant on various criteria, such as the stand height of the area, the amount of canopy cover, the area's strip width, the degree to which grasses are included in the area (or the degree to which different types of trees are included for “mixed” forest areas and so forth) and rates of growth for timber production. The last of these, particularly, can be an issue which makes it difficult to reconcile different maps collected from different sources; for example, some organizations may classify areas that have been recently logged and which have no trees whatsoever as “forest cover” if the intention is to replant those areas, or may classify areas as forest cover based on the growth rate of the trees in the area, meaning that a recently-logged area without any trees may be labeled as “forest” whereas a partially-developed area which still has many trees may not be labeled as “forest.” Other organizations may not make these distinctions or may make other distinctions.

In certain exemplary embodiments, then, it may be contemplated for multiple tags to be applied to a given area. For example, if three different maps of an area from three different sources are incorporated into the training, different tags may be applied from each map, which may be used in order to give the overall process greater insight into the underlying land use or land cover.

For example, if it is known that a certain area is “mixed forest” on a first map, “deciduous forest” on a second map, and “low-intensity development” on a third map, and each of the maps have different standards as to how to classify areas that lead to this result, the system may be able to reconcile these standards as part of the machine learning process. Such a result may mean that the system knows that the tree cover in the area is greater than A % and percentage of deciduous tree cover in the area is between B % and C % (based on the first map), knows that the intended tree cover in the area post-replanting will be greater than D % and that the percentage of deciduous tree cover in the area is greater than E % (based on the second map), and that the degree of development in the area is between F % and G % (based on the third map), allowing more detailed conclusions to be drawn about this area and about other areas shown on any of the three maps (or on any future maps derived from the same organizations).

Further, in an exemplary embodiment, it may be contemplated to incorporate the underlying models used to generate this data as part of a “transfer learning” process. Transfer learning is a process for building accurate models in a timesaving manner by starting from patterns which have been learned when solving a different problem, through the use of pre-trained models. In such an embodiment, unlabeled maps may be used as an initial starting point, and various public geographic information system (GIS) maps that have applied various categorizations to each area may be used as labeled training data, allowing the maps to be reconciled in the final algorithms specifically via a transfer learning process.

While the data that may be paired with or derived from the maps incorporated into the training algorithm may include land use and/or land cover data, it is of course not limited thereto, and other relevant data points from other maps may be incorporated into the overall analysis (and, to the extent necessary, combined with other mapping data). Relevant data points for each pixel may include, but are not limited to, historical and/or current climate data, geographical data, human-use data, and visual data. Climate data may include, for example, temperature data, wind data, and rainfall data. Geographical data may include information such as mineral compositions, soil compositions, and drainage rates. Human-use data may include information such as carbon emissions, population density, land zoning, sophistication of technology, and information pertaining to structures at that pixel and the building materials of which they are composed. Visual data may include information such as color, visibility and/or haze, reflectivity, and incorporate sensor readings in spectrums such as infrared, the visual spectrum, and the ultraviolet spectrum.

The deep learning algorithms may then engage with the human-tagged training maps and derivative pixels, establishing the necessary rules and correlations with which to build an appropriate model in a supervised fashion. As noted, training may also be conducted in a semi-supervised fashion; for example, the algorithm may be trained on both human-tagged and untagged pixels simultaneously, or the algorithm may be trained on human-tagged pixels first and untagged pixels may then later be incorporated to make the resulting model more robust.

Each resulting model may then be evaluated based on accuracy in reproducing the human-tagged pixels, until a sufficient accuracy rate is achieved.

The deep learning algorithm may utilize one of several paradigms, including Convolutional Neural Networks, Recurrent Neural Networks, and/or Stacked Auto-Encoders. The algorithm may also incorporate Clustering algorithms and/or Instance-Based algorithms.

The resulting trained model, the “dynamic mapping model,” thus allows for subsequent data imports to the system to be automatically and accurately tagged, reducing the amount of necessary human input. Each static dataset can then be incorporated into, thus making more robust and increasing the utility of, the dynamic land map.

A dynamic land map may be presented, via an exemplary user interface, effectively by adding a time component to the LULC map. This may be used in order to demonstrate how the dynamic land map changes over time, such as changing from forest to grasslands to agriculture or settlements over months or years. It may further be contemplated to apply further dynamic science products to the dynamic land map concept; for example, it may be contemplated to, based on biomass carbon density estimates for types of land use, produce a dynamic carbon map showing the global distribution of biomass carbon density (metric tonnes per square kilometer). This may be produced by, for example, a per-ecoregion model of biomass carbon density per land cover category applied to the global dynamic map of land cover categories. Another example may be a dynamic human footprint map that uses the dynamic land map to provide continuous updates of human infrastructure and loss of natural land cover (through deforestation or fire activity). Another example may be a dynamic land condition map formed by combining a global observations of vegetation health with global dynamic map of land cover categories and tracking multi-year cycles of ecological health (agricultural cycles, fire/flood recovery, irreversible conversion of natural land cover to human use). Machine learning algorithms may be used to construct the per-ecoregion models that estimate carbon or condition from land cover type and other geospatial auxiliary datasets (e.g., topographic information on altitude and terrain gradients, climatological information on average rainfall or hours of direct sunlight). This is particularly the case for models that use current and historical time series to predict future values of land cover, carbon, human impact, or condition.

In an exemplary embodiment, it may be contemplated to pre-generate such maps for a given area, such as a country or region or even the entire globe, and stored for efficient retrieval. In an alternative exemplary embodiment, maps may be generated on request from component maps. (For example, it may be contemplated to generate the “dynamic carbon map” based on dynamic mapping data for a region and carbon estimate density data corresponding to that particular region, e.g. forest carbon density data at a first latitude as opposed to a second latitude.) In general, the preprocessing of large areas may ensure that the system does not collapse when required to process large areas, while optimizing the system for on-demand processing for small areas may use fewer storage resources but be much slower and more unwieldy at larger-scales.

The datasets may include references for factors being measured by the data. Factors being measured may include carbon level, biodiversity, human impact, natural disasters, or any other factor relevant to the index at issue.

The data may be stored in a remote location. The data may be stored in a decentralized fashion.

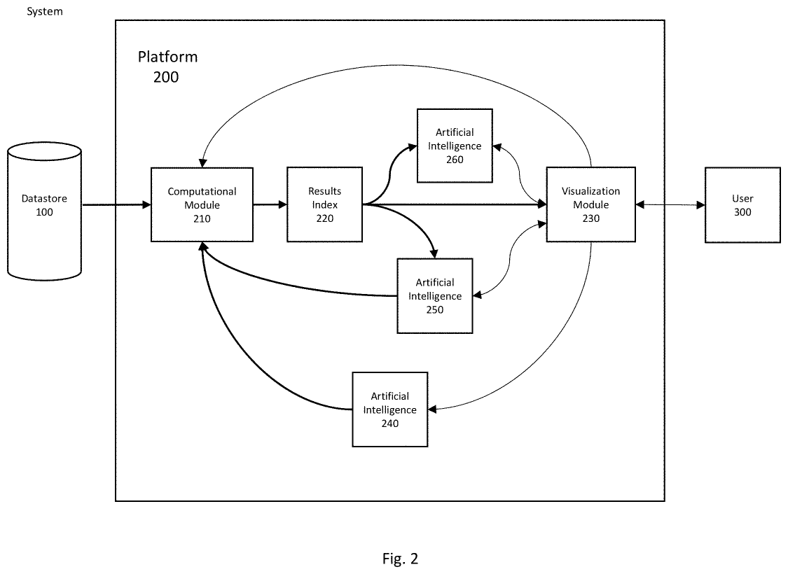

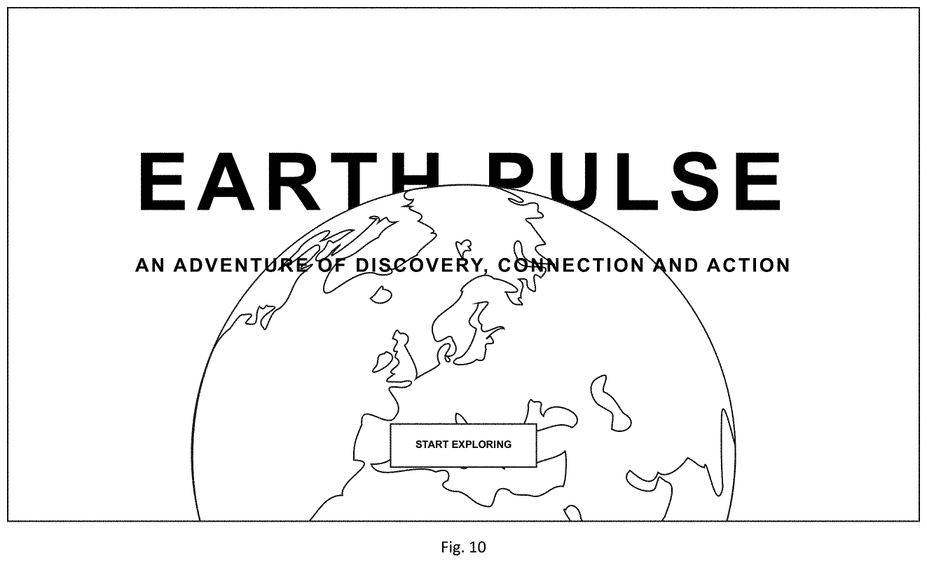

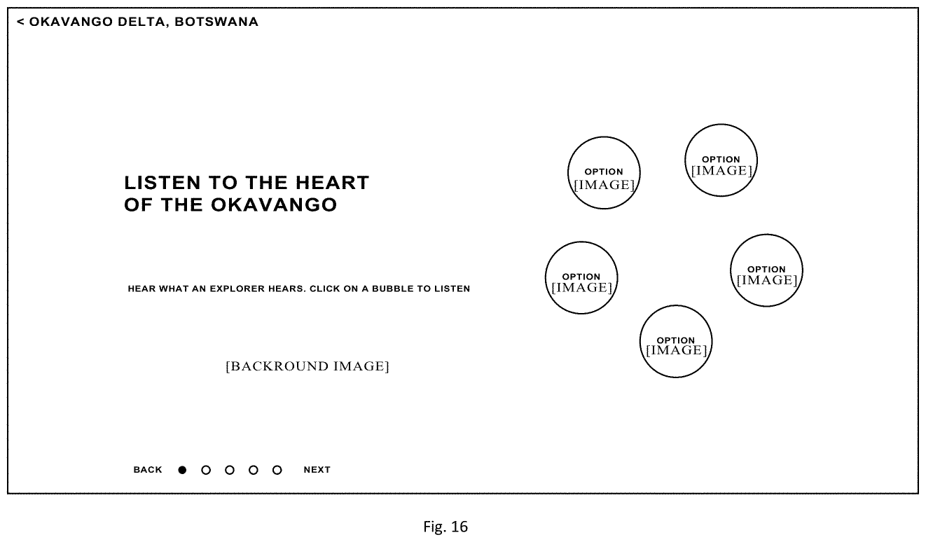

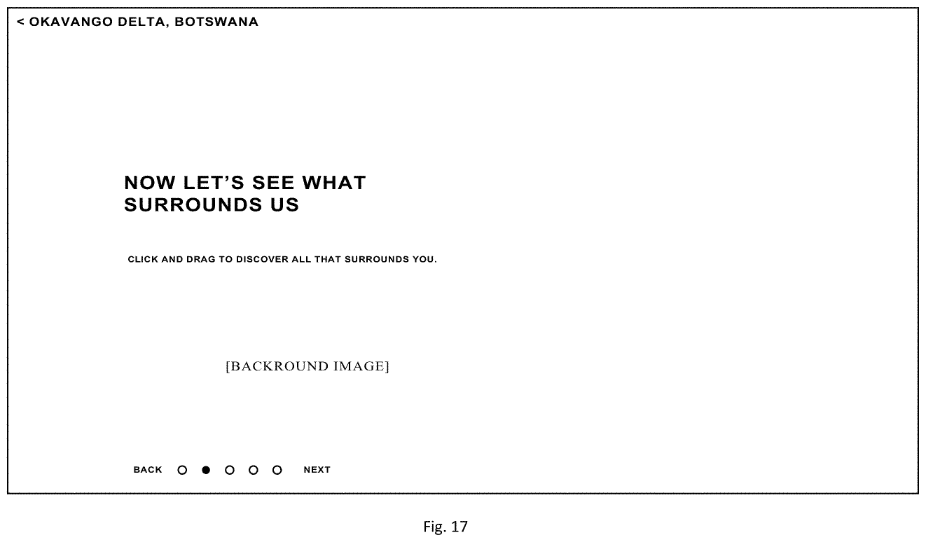

Turning now to exemplary FIG. 2, FIG. 2 displays an exemplary embodiment of a system for evaluating, exploring, and predicting the status of regions of the planet through time. The system may include a datastore 100 and a platform 200, which may be interacted with by a user 300. The platform may include a computational module 210, a results index 220, a visualization module 230, and one or more artificial intelligence modules, such as a first artificial intelligence 240 (which may be configured to look at regions of interest 271 and factors of interest 272), a second artificial intelligence 250 (which may, for example, be a recommender system configured to analyze actions of interest 273), and a third artificial intelligence 260 (which may be configured to provide alerts of interest 274). The visualization module 230 may include virtual or augmented reality, graphical user displays on a personal or mobile device, or any other visual interface. Turning now to FIG. 10, FIG. 10 displays an exemplary user interface for a platform and method for evaluating, exploring, and predicting the status of regions of the planet through time. Turning now to FIG. 16, FIG. 16 displays an exemplary user interface for a platform and method for evaluating, exploring, and predicting the status of regions of the planet through time. FIG. 16 may show options for the user to hear sounds from the region of interest 102. Turning now to FIG. 17, FIG. 17 displays an exemplary user interface for a platform and method for evaluating, exploring, and predicting the status of regions of the planet through time. FIG. 17 may show options for the user to explore the region of interest 102 from the perspective of someone who is in the region of interest 102. FIG. 17 may display a 3D exploration mode for the selected region of interest 102.

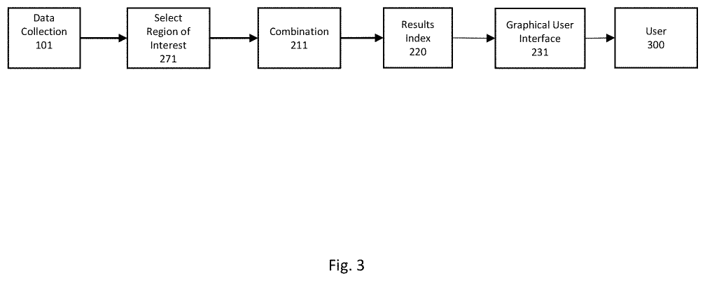

Turning now to exemplary FIG. 3, FIG. 3 displays an exemplary embodiment of a method for evaluating, exploring, and predicting the status of regions of the planet through time. The method may include data collection 101, selection of a region of interest 102, data combination 211, provision of a results index 220, and display on a graphical user interface 231 to a user 300.

A selected region of interest 102 may be chosen. The region of interest 102 may be identified by a closed shape. The closed shape may be defined using any collection of vectors. For example, a closed shape may be based on a selected point and radius, a selected geographic feature and distance, or any drawn, pre-prepared and inputted, or may be based on another user identified shape. In an exemplary embodiment, the definition of a user-identified shape may be formed via a plurality of vectors, such that a vector or collection of vectors may be used to define a polygon as a collection of vectors (which may correspond to a protected area), a line as a vector or series of vectors (which may correspond to the path of a river), or a point or a region based on a point of interest (such as an area within a certain point of interest). Unions of such shapes may also be contemplated; for example, a union of lines may be used to define a river complex, or a union of polygons may be used in order to define a set of protected areas. (These unions may, in some circumstances, be subject to different analysis than its constituent protected areas, if desired; for example, it may be desirable to look at a migration pattern between protected areas, which may require analysis of how the migrating animals interact with the entire union set.) The region of interest 102 may focus on an area near a particular city, country, continent, ecosystem, biome, biosphere, body of water, geographical feature, etc. The region of interest 102 may not be contiguous and may isolate separated areas with a commonality including an island arc, separated habitats for a specific species of animals, or any similarly identified region. The region of interest 102 may be selected for education, exploratory, or entertainment purposes or to inform policy decisions about the area.

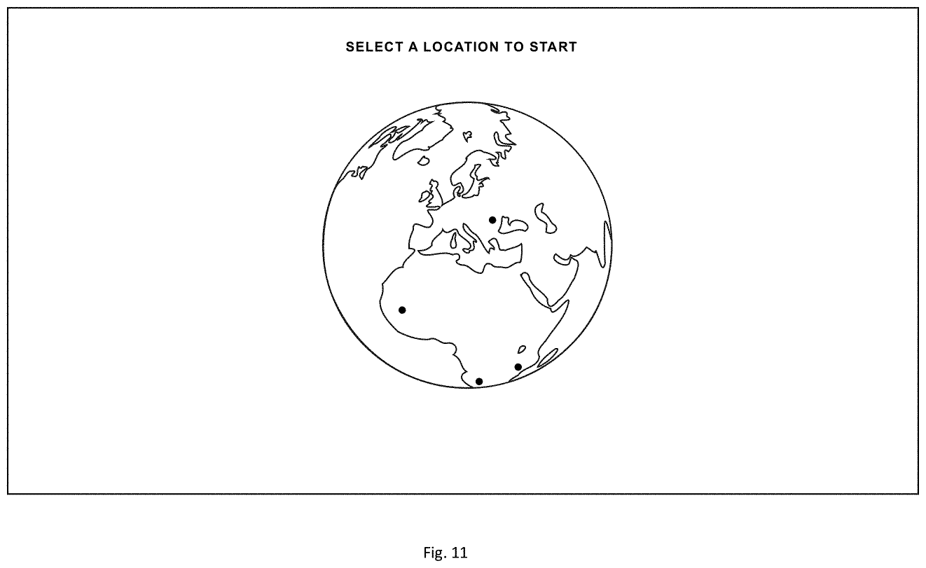

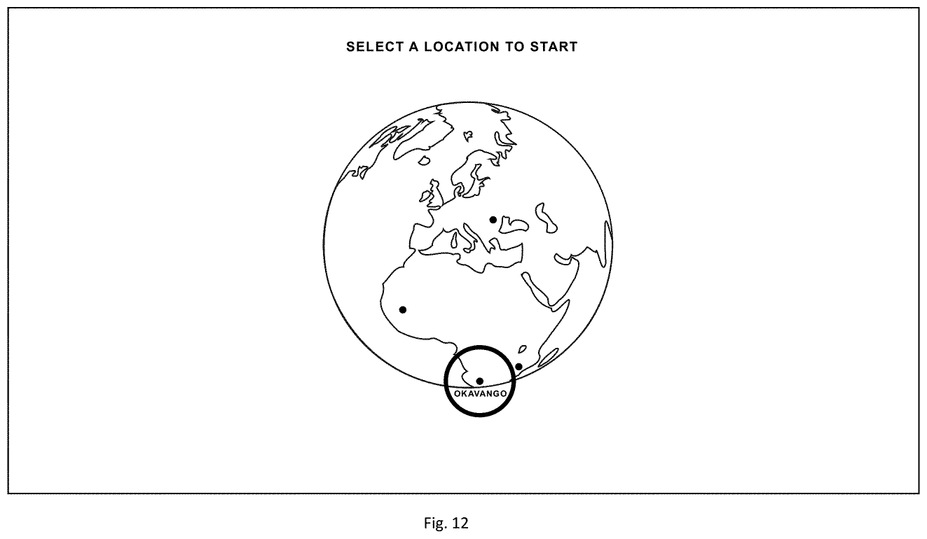

Turning now to FIG. 11, FIG. 11 is an exemplary user interface for selecting a region of interest. The user may be presented a screen to select a region of interest 102. Turning to FIG. 12, FIG. 12 is an exemplary user interface for selecting a region of interest. The user may choose a location within a region of interest 102 on a map or other representation. A region of interest 102 may be selected based on the click of a mouse, by the touch of a screen, by typing the name of a known area, or other means of instruction on the graphical user interface 231. A region of interest 102 selected may correspond to natural or political boundaries or by distance from the point of selection.

Data from the data collection 101 and datastore 100 associated with the selected region of interest 102 may go through a combination 211 step. Due to the wide variety of data which may be collected in the datastore 100, the time at which it was collected, the selected area of interest 102, and/or selected factors of interest 272, the data as stored may not be in a format suitable for processing the task at hand. The data as stored may also not be in a form such that combination 211 of one dataset with another would be contextually appropriate. In this manner, combination 211 may also normalize one or more datasets according to a guiding scientific, political, philosophical, etc. principle to ensure a desired and useful result.

The combination step 211 may take place immediately after the selection of a region of interest 271, or it may also be done ahead of time due to user- or AI-indicated areas and/or factors of interest such that the information is cached in the datastore 100 for faster and more efficient recall by users.

Combination 211 may be necessary to reconcile datasets stored in different formats, and thus represents a straightforward conversion of the format of one dataset to another format, as is conventionally known in the art, to enable like processing of the data.

Combination 211 may be necessary to reconcile data that was submitted asynchronously, either through a dataset that was updated with newer information or when combining two different datasets which were collected at different times.

Combination 211 may also be conducted on a contextual level through the use of machine learning. In this sense, combination 211 exceeds normal inputting formatting or conditioning as is commonly known in the art. Contextual combination 211 of one dataset with another takes into account differences inherent in the data of each dataset to ensure a normalized and useful result is displayed. For example, these contextual normalizations may compensate for seasonal variances, long term atmospheric cycles, long term geologic cycles, environment cycle variations, or any other periodic variances. The contextual normalizations may also compensate for sudden natural events such as a volcano eruption, hurricane, or other transient environmental effect that is not periodic in nature. Such transient events may serve as extreme outliers which may skew data results, and the flagging of this fact for exclusion may be untenable, undesirable, or counter-productive for users who may wish to view such events.

With sufficient quantities of datasets, an AI or machine learning algorithm may be trained to recognize these periodic cycles and/or these transient events such that during combination 211, such events may be usefully normalized and considered in the generation of the results index 220.

The combination step 211 may also be used to compensate for gaps in the retrieved datasets. Contextual combination 211 need not be conducted in a like-factor basis.

For example, a user may be interested in rainfall data for a given region at a certain point in time, however, at that point in time, only part of the region has available rainfall data, while the rest only has temperature data. If the AI can confidently reconstruct the missing rainfall data based on the available temperature data, the two datasets may yet be combined. Such capability may be obtained through the aforementioned training and/or additional training of the AI to recognize relationships between various factors in certain regions. The AI may incorporate additional coarser or finer datasets, or datasets from other reference time points, to improve these predictions and/or reconstructions. The confidence level may be specified by the user, hard-coded into the algorithm, or determined based on any error or accuracy ranges provided with the datasets.

Once a dataset has been incorporated into the system and properly labeled, it may serve as a set of training data for another machine learning algorithm or AI to generate an interpolative model. This interpolative model is preferably separate from the dynamic mapping model; however, the two may be configured to interface with one another.

Because the interpolative model is trained on both human-labeled datasets and datasets labeled by the dynamic mapping model, the training regime of the interpolative model is preferably of a supervised nature.

Preferably, training is conducted on datasets that are relatively complete. In this manner, certain variables of a dataset may be removed—simulating an incomplete dataset—and the model is evaluated on its ability to recreate the missing data. This recreated data is then compared against the data which was removed in simulation to determine an accuracy rating. This accuracy rating is then used to drive the training of the model. These removed variables may be removed on either a random basis or on the basis of a heuristic which tracks those variables most likely to be absent from a dataset based on past submissions.

For example, in one embodiment, a dataset may comprise carbon storage, biodiversity intactness, habitat intactness, agricultural footprint, urban/settlement footprint, or human impact. Each one of these subsets of the dataset may be selected at random, in whole or in part, for deletion in order to create a training dataset. Alternatively, historical data submissions may reveal that all or most datasets are submitted with temperature data intact, so that training the interpolative model on a training dataset which lacks temperature data may either improperly guide the resulting interpolative model through training or lead to a waste of computational resources. As such, those subsets of data selectively removed to create training datasets may prioritize those subsets of data which are frequently missing from submitted datasets, based on past and/or historical submission statistics. These historical statistics may be used to formulate a heuristic to create a probability distribution as is known in the art so that the randomized deletion is not purely random but follows a prescribed distribution curve.

Preferable machine learning paradigms for the interpolative model include Deep Learning algorithms such as Stacked-Auto-Encoders, Artificial Neural Networks, Regression algorithms such as Multivariate Adaptive Regression Splines, Decision Tree algorithms, or Ensemble algorithms.

In an exemplary embodiment, it may be contemplated to implement these machine learning algorithms using KERAS and TENS ORFLOW, though any other analogous frameworks may also be contemplated. For reference, TENSORFLOW is an end-to-end platform intended for use in the construction and deployment of machine-learning models, which specifically allows models to be built and trained with the high-level KERAS application programming interface (API), a neural network library containing numerous implementations of commonly used neural-network building blocks such as layers, objectives, activation functions, optimizers, and other tools intended to make working with image and text data easier to simplify the coding necessary for writing deep neural network code. TENSORFLOW and KERAS support multiple different types of neural networks, such as standard, convolutional, and recurrent neural networks, all of which may be contemplated for use in any of the exemplary embodiments provided herein.

Because the system collects datasets in time as well as spatially, a predictive model trained similar to the interpolative model can thus provide additional functionality to the user.

Similar to the interpolative model, the predictive model may be trained on datasets that are more sufficiently complete, but in both space and in time. It may also be necessary, or even preferable, to utilize datasets which have passed through the interpolative model to reach a fidelity level necessary to properly train the predictive model.

Likewise, with the interpolative model, pieces of these complete datasets may be selectively removed with the goal of training the model to recreate the missing data. While one comprehensive model is preferable, it may also be preferable to train three separate models: a forwards-stepping predictive model which proceeds from an initial timestep, a backwards-stepping predictive model which works backwards from a final timestep, and a midpoint predictive model which recreates intermediate timesteps between an initial and a final timestep.

Given the large computational requirements this temporal prediction may encompass, it is further advantageous to use the interpolative model in conjunction with the predictive model. In this manner, the predictive model may be used to extrapolate certain core datasets only, limiting the computational space. These extrapolated core datasets are then used to establish a new data timestep which the interpolative model may then expand as necessary, filling out the missing data. Through this cooperation, a more efficient process may be achieved.

The predictive model thus allows a user to fill temporal gaps in the dataset and explore conditions for which raw data was previously unavailable. The predictive model also allows a user to view the evolution a region over time given the known conditions. The predictive model also allows a user to specify an action or a set of actions to take in a region of interest 271. This action or set of actions may be represented as a static change or a dynamic change. A static change may represent a simple change in initial conditions from which the predictive model proceeds in a forward-stepping manner A dynamic change may represent a change over time of one or more datasets, necessitating an iterative approach using the predictive model as an integrative function. Thus, the forward stepping, reverse stepping, and/or midpoint sub-models of the predictive model may be used to simulate the gradual change.

The relevant data from the data collection 101 from the region of interest 271, whether it be comprised of raw data, data output by the interpolative model, and/or data output by the predictive model, may be used to calculate a results index 220. The results index 220 may indicate the environmental success, health, or growth of the region of interest 271. The results index 220 may be calculated regularly or when prompted by the user 300. The results index 220 may represent a current status or a projected future status. The results index 220 may be used to represent trends in the region or show an outcome over time. Multiple results indices 220 may be combined to produce a time series showing the change over time. Multiple time series may be produced to allow the user to compare various regions of interest 271 over time. For example, the user may select the habitat of the black rhino as one region of interest 271 and compare the produced time series of results indices 220 with that produced when the habitat of giraffes is selected instead.

The results index 220 may be produced from the relevant data collection 101 using an algorithm. The algorithm may calculate, combine, and transform indices of specific factors including biodiversity, carbon, human impact, natural disasters, or any others to produce the results index 220.

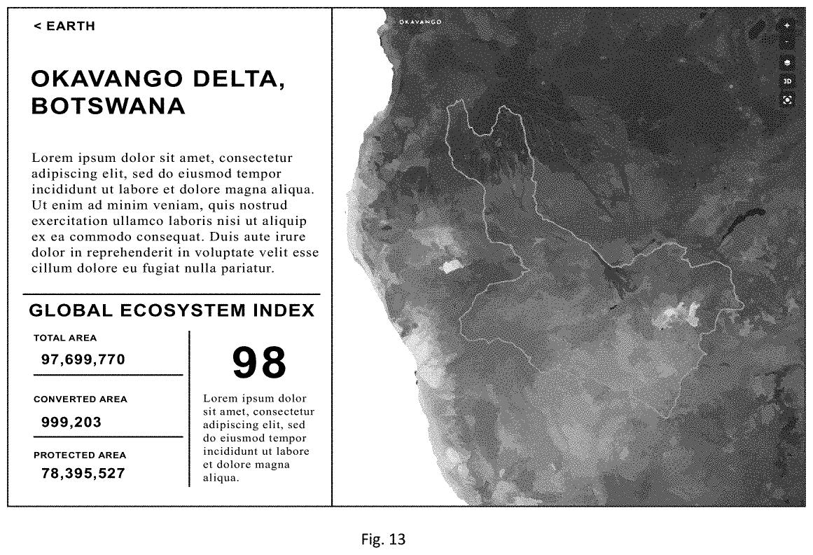

The results index 220 may be represented to the user using a graphical user interface 231. The graphical user interface 231 may include a dashboard. The dashboard may show the results index 220, the region of interest 271, and the data included. The graphical user interface 231 may incorporate augmented reality or virtual reality technology. The graphical user interface 231 may use a personal or mobile device. Turning now to FIG. 13, FIG. 13 is an exemplary user interface for a platform and method for evaluating, exploring, and predicting the status of regions of the planet through time with a region of interest and an index. FIG. 13 may display, e.g., the Okavango Delta in Botswana as a region of interest 102. The graphical user interface 231 may display a results index 220 of the appropriate index value for the region of interest 102.

The results index 220 may be tailored on the basis of one or more underlying target values and/or threshold values. For example, a target carbon emissions value can be set directly by the user, determined from a policy structure chosen or input by the user, or determined from carbon emission values found in similar datasets contained in the overall database. These target and/or threshold values are then reflected either positively or negatively in the results index 220 displayed to the user.

A policy structure submitted by the user may encompass a goal of, for example, reducing carbon emissions by 10% over the next 10 years. This policy may then impose a static or dynamic target on changes in carbon-rich natural structures (e.g., forests or wetlands) to be reflected in the results index 220 as the user views data at different timesteps or as a time series. The user may then use this information to recommend or plan action to be taken, such as initiating a reforestation project in the region of interest 102 which would lead to an increase in the relevant datasets. As the user views various timesteps or the predictions of the model through a time series, the results index 220 of carbon emissions over that time may then reflect how well or poorly the reforestation project improves projections related to carbon emissions. In a scheme where maximizing the results index 220 is seen as beneficial, if the reforestation project is predicted to reduce overall emissions, then the time series of results index 220 for carbon emissions will show an increase. If the reforestation project is predicted to be insufficient, the time series of results index 220 for carbon emissions may decrease.

In those situations where the user may not know of an appropriate target or threshold for a given results index 220 to provide more meaningful utility, the user may query the whole database for such information. In this manner, datasets with sufficiently similar contexts may be used to discern an appropriate target or target policy for the user. The biodiversity results index 220 of a national park region with certain geographical and climatological conditions may be used as a target value for a similar national park region that is looking to undergo remediation to improve its biodiversity results index 220. Because of this, real and useful targets may be created and employed by those with little skill in the underlying systems.

With the region of interest 102 selected, the user may thus query the database for similar regions from which to draw reasonable target or threshold values. The system may be configured to pick the closest match without further user input, or an array of similar results may be displayed to the user. Notable differences between the region of interest 102 and the similar regions may be displayed to the user to aid in the selection of an appropriate analog. In this manner, result indices 220 may be employed to highlight these differences in a user-friendly manner to again lower the threshold of skill needed by a user.

Searching for similar regions may be employed in contexts other than finding appropriate threshold or target values. Multiple regions of interest 102 may be selected for side-by-side comparison.

Specified target and/or threshold values—derived from policies—may thus be used to compare how the multiple selected regions of interest 102 compare to the specified targets and/or thresholds. In this manner, the selected regions of interest 102 may be sorted or ranked on the basis of how each region performs with respect to the specified targets and/or thresholds. Based on these comparative results, regions may be flagged for action or later investigation or prioritized in other processes for investigation. For example, given a remedial project with limited budget or scope, it may be advantageous to use such a ranking to prioritize those regions which should be the focus of more or less extreme remediation.

These specified target and/or threshold values, as well as the at least one selected region of interest 102, may further be stored for temporal monitoring. In this sense, as newer data is added to the database, results indices 220 for these selected groups may be persistently updated and tracked. When a tracked result index 220 falls passes a threshold or a related alarm limit, an alert message may be generated for the area and/or areas of interest 102 that are affected. This alert may be communicated to the user either through the platform, via email, via text message or SMS, or any conventional communication method as understood in the art. In an exemplary embodiment, multiple communication modalities may be used in order to convey this information, optionally simultaneously; for example, in an exemplary embodiment, it may be contemplated to have a platform provide an alert on a local device that a user is signed into, and simultaneously send one or more alerts via rapid-transmission modalities to the user, such as by email, by text message, by push alert on some other device, or any other instantaneous or near-instantaneous form of communication.

A user may further define further analyses to be conducted when such a threshold or alarm limit is reached, and the alert communicated to the user made contingent on the result of this analysis. For example, an alarm limit may be set for the results index 220 pertaining to area growth in human settlements in a region of interest 102. When this alarm limit is passed, the system automatically queries the availability of datasets pertaining to biodiversity for that same region of interest 102, and if said data is not inputted in a raw form to the system, then the interpolative model is used to generate the data. Based on the computed results index 220 for biodiversity of the area of interest 102 and how it compares to another threshold value or target set by the user, the system may then alert the user through one of the aforementioned communication methods.

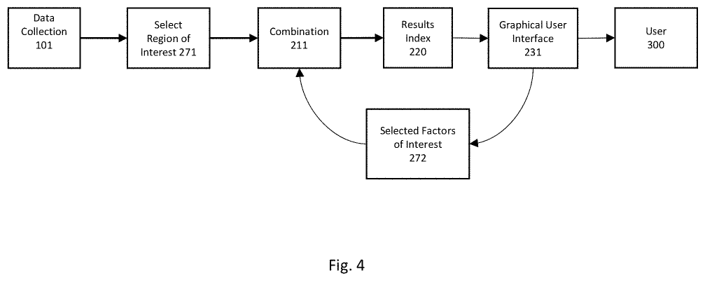

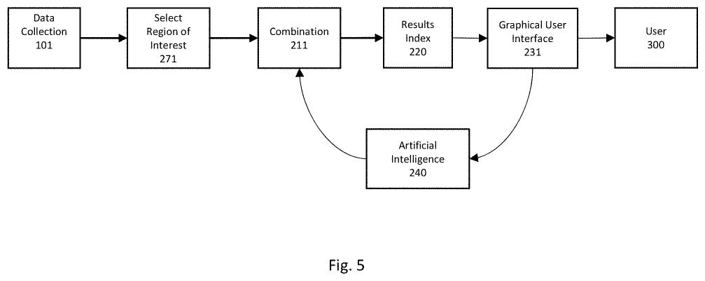

Turning now to exemplary FIGS. 4 and 5, FIG. 4 displays an exemplary embodiment of a method for evaluating, exploring, and predicting the status of regions of the planet through time with selected factors of interest, while FIG. 3 displays an exemplary embodiment incorporating artificial intelligence to select the factors of interest. The method may include data collection 101, selection of a region of interest 271, combination of relevant data 211, a results index 220, a graphical user interface 231, a user 300, and selection of factors of interest 272. FIG. 3 displays an exemplary embodiment incorporating artificial intelligence 240 to select the factors of interest 272. The artificial intelligence 240 may be trained to select relevant aspects from the data to produce a more helpful results index 220 for the user.

Using a graphical user interface 231, the user 300 may select one or more factors of interest 272 within a region of interest 271. The factors of interest 272 may include migration patterns, urban growth, biodiversity, precipitation, temperature, air quality, or any other category of evaluation of an area or population. The factors may be used to evaluate the region of interest 271 in real time. The factors may be used to evaluate a predicted state of the region of interest 271 in the future. The one or more factors of interest 272 may be selected using artificial intelligence 240. The artificial intelligence 240 may factor in previous decisions by the user 300 or other users worldwide. The selected factors of interest 272 may then be used to refine the combination 211. The refined combination 211 may then be used to calculate a results index 220 describing the region of interest 271. The results index 220 reflecting the selected factors of interest 272 may then be represented on the graphical user interface 231. The graphical user interface 231 may show the results index 220 prior to factor selection along with the results index 220 including factor selection alongside each other. The graphical user interface 231 may show multiple results indices 220 accounting for various selections.

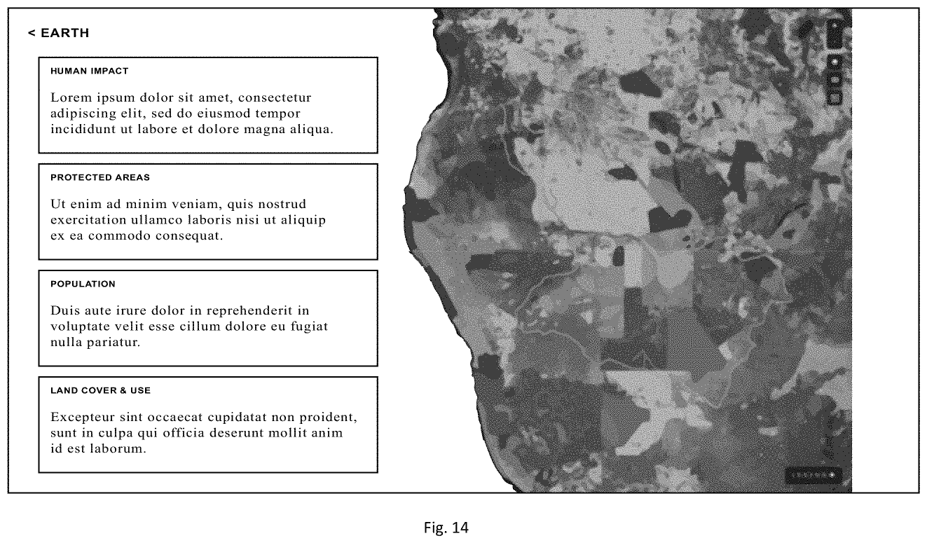

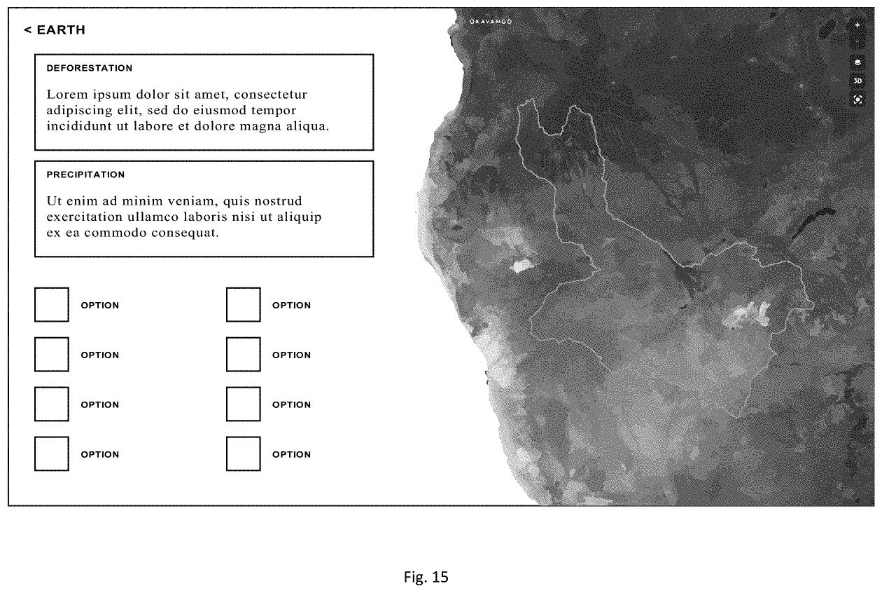

Turning now to FIG. 14, FIG. 14 is an exemplary user interface for a platform and method for evaluating, exploring, and predicting the status of regions of the planet through time with selected factors of interest. FIG. 14 may display the selection of human impact and protected areas as factors of interest 272 within a region of interest 102. Turning now to FIG. 15, FIG. 15 is an exemplary user interface for a platform and method for evaluating, exploring, and predicting the status of regions of the planet through time with options for related regions of interest. Related regions of interest may be selected by artificial intelligence. Related regions of interest may give the user the option to narrow their field or to explore related regions to the one they have selected.

In an exemplary embodiment, a user 300 may be concerned with the biodiversity of fauna on a continent. The user 300 may be a student, an advocate, a researcher, an expert, or other person with an interest in the area. The user 300 may have used a graphical user interface 231 to select the continent as a region of interest 271. The user 300 may not be focused on the levels of precipitation or the flora in the region of interest 271 and may wish to exclude data relating to those factors from an index 220 produced for region of interest 271. The user 300 may use a graphical user interface 231 to either include factors of interest 272 that relate to biodiversity of fauna or to exclude factors that relate to precipitation or biodiversity of flora. The factors of interest 272 for the user 300 may be used to refine the data used for the region of interest 271. The combination 211 may then produce a new results index 220 tailored to the factors of interest 272 in region of interest 271 for the user 300. The user 300 may then have a better understanding of the overall health with respect to the topic of interest they are looking to understand better. In another exemplary embodiment, the method may include artificial intelligence 240 that would assist the user 300 in selecting factors of interest 272. The artificial intelligence 240 may include factors of interest 272 that are related to a specific subject, exclude factors related to a subject, include factors that have been grouped together by users before, or similar behavior. (This may include, for example, targets or thresholds that the user 300 has used before or which are otherwise in their usage history, or targets or thresholds that some set of multiple users have commonly used before or which are otherwise in the multiple users' usage history. Exemplary sets of multiple users may include, for example, all other users or users with a similar profile to the user 300.)

The system additionally has an application programming interface, or API, which allows a user to interface with the system through means other than the graphical user interface. Such an API thus allows a user to create their own graphical interface to work with the system, or to interface with the system on a command-line basis, or to use automation tools as are known in the art to more effectively utilize the system. The API allows for the creation of additional software and provides a means for said software to efficiently access the data and analyses of the system outside of the graphical user interface.

The API of the system may incorporate security measures which limit a user's access and or the actions a user can take while interfacing with the system. Access may be restricted on the basis of a user-password system, a 2-factor authentication system, a PKI authentication system, or any conventional access-control system as is known in the art.

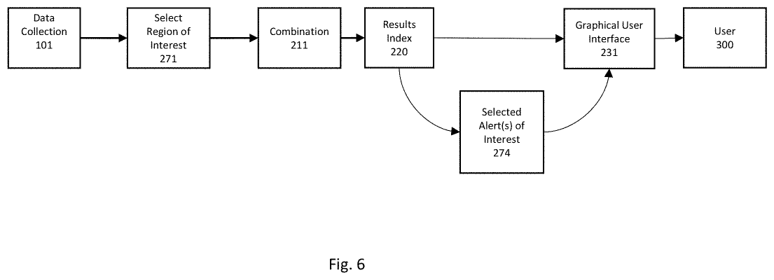

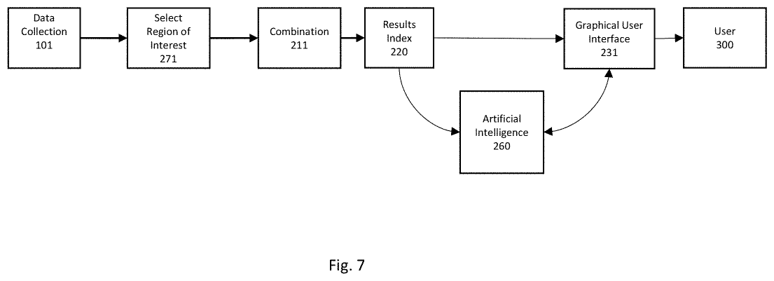

Turning now to exemplary FIGS. 6 and 7, FIG. 6 displays an exemplary embodiment of a method for evaluating, exploring, and predicting the status of regions of the planet through time with selected alerts of interest, while FIG. 7 displays an exemplary embodiment incorporating artificial intelligence to select the alerts of interest. The method may include data collection 101, selection of a region of interest 271, combination of relevant data 211, a results index 220, a graphical user interface 231, a user 300, and selection and use of alerts of interest 274. FIG. 7 displays an exemplary embodiment incorporating artificial intelligence 260 to select the alerts of interest 274.

Using a graphical user interface 231, the user 300 may select one or more alerts of interest 274 for the results index 220. The alerts of interest 274 may be triggered when the results index 220 value goes above or below a certain level. The alerts of interest 274 may be displayed on the graphical user interface 231. The alerts of interest 274 may be displayed using the visualization module 230. The alerts of interest 274 may go to a mobile device, a personal device, or may be provided within an augmented or virtual reality display. The display may show a different color, sound, label, picture, icon, pattern, or other representation to indicate whether the value is at, below, or above the threshold level in the alerts of interest 274. The alerts of interest 274 may be selected using artificial intelligence 260. The artificial intelligence 260 may factor in previously selected alerts of interest 274 by the user 300 or other users worldwide.

In an exemplary embodiment, a user 300 may want to be alerted when the results index 220 of a particular region changes in a particular way. The user 300 may be an expert who has predicted that the health of a river valley would suffer from a dam being built upstream. The user may enter the river valley into a graphical user interface 231 as a region of interest 271. The region of interest 271 may have a results index 220 value of 83 at the time. The user 300 may set an alert of interest 274 for 80. The graphical user interface 231 may then alert the user when the results index 220 of region of interest 271 drops below 80. In an exemplary embodiment, the graphical user interface 231 may alert the user when the river valley has a results index 220 of 79 with an email or a text message to their phone. In other exemplary embodiments, the alert of interest 273 may trigger a sound alert within a virtual reality interface or with a badge on a dashboard, webpage, or screen. In another exemplary embodiment, the method may use artificial intelligence 260 to set an alert of interest 274 based on previous entries, previous changes to indices over time, expected changed to indices over time, or any other relevant factors that go into setting a threshold.

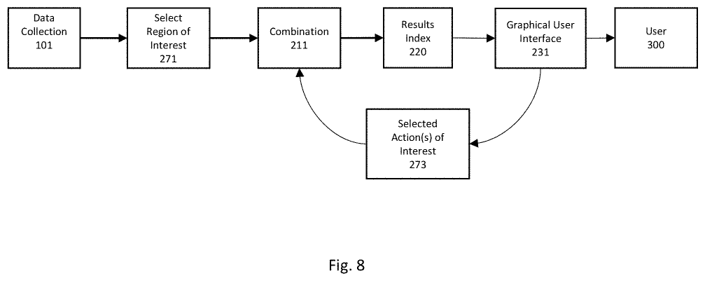

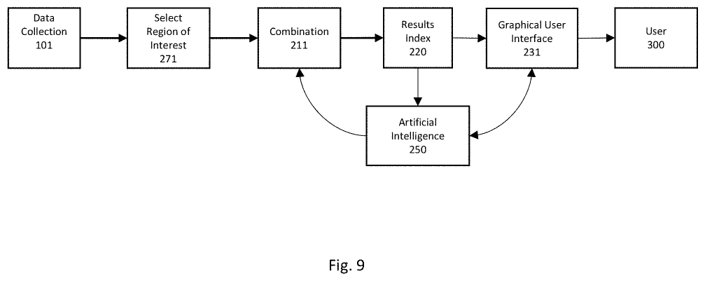

Turning now to exemplary FIGS. 8 and 9, FIG. 8 displays an exemplary embodiment of a method for evaluating, exploring, and predicting the status of regions of the planet through time 100 with selection for actions of interest, while FIG. 9 incorporates artificial intelligence to identify actions of interest. The method may include data collection 101, selection of a region of interest 271, combination of relevant data 211, a results index 220, a graphical user interface 231, a user 300, and selection of actions of interest 273. FIG. 9 displays an exemplary embodiment incorporating artificial intelligence 250 to select the actions of interest 273.

Using a graphical user interface 231, the user 300 may select one or more actions of interest 273. Actions of interest 273 may include policy decisions relating to region of interest 271. Actions of interest 273 may include regulatory environmental protections, public and private infrastructure organization, resource consumption, waste production, migration patterns, taxation, and any other decision that could impact a region. The actions of interest 273 may include an isolated action, a regularly conducted behavior, or a continuous set of actions or prevented actions. The one or more actions of interest 273 may be identified using artificial intelligence 250, which, as noted, may in some exemplary embodiments be a recommender system. The user 300 may be asked if they would like artificial intelligence 250 to identify suggested actions of interest 273 through the graphical user interface 231. The one or more actions of interest 273 may then be selected by artificial intelligence 250 and suggested to user 300. The suggestion may include an expected results index 220 for the action. The artificial intelligence 250 may factor in previous decisions by the user or other users worldwide or actions taken in the past; for example, an exemplary embodiment of an artificial intelligence 250 may provide a recommender system that looks at past decisions that the user 300 has made regularly for similar regions (with similarity optionally being defined based on one or more attributes) and, to a lesser extent, for other regions, and also looks at past decisions of other users who are believed to be most similar to the user 300. Artificial intelligence 250 may identify actions of interest 273 associated with a certain region of interest 271 or regions similar to the region of interest 271. Artificial intelligence 250 may identify actions of interest 273 associated with a certain results index 220 change. Artificial intelligence 250 may identify actions of interest 273 associated with a desired results index 220 or change in result index 220. The selected actions of interest 273 may then be used in combination 211. Combination 211 may then calculate a results index 220 describing the region of interest 271. The results index 220 reflecting the selected actions of interest 273 may then be represented on the graphical user interface 231. The results index 220 may be generated based on a variable amount of time passed. The results index 220 may represent the region of interest 271 after one month, or after one year, or after 20 years. The graphical user interface 231 may show the results index 220 prior to action selection along with the projected results index 220 including actions of interest 274 alongside each other for comparison. The graphical user interface 231 may show multiple results indices 220 accounting for various actions of interest 273 selected.

In an exemplary embodiment, a method disclosed may inform the decision-making process of a user 300. The user 300 may be a policy maker including a governor, a head-of-state, a legislator, a zoning board member, or an individual inhabitant. The individual may be interested in a region that they live in, like a country, a city, a state, or a hemisphere. The individual may be presented with a decision about a policy that may impact the country they live in. The policy may limit water usage, decrease pollution in the air or water, or protect an individual species from hunting or habitat from recreational use. The individual may use a graphical user interface 231 to select a region of interest 271 corresponding to the country they live in. Data from the data collection 101 corresponding to the region of interest 271 may be taken for combination 211. Combination 211 may produce results index 220 representing the overall status of the region of interest 271. The user may select an action of interest 273 on the graphical user interface 231. The action of interest 273 may correspond to the policy decision the user was presented with, such as a decision to classify the region of interest for protection, restoration or management. The user 300 may then be presented with another results index 220 on the graphical user interface 231 factoring in the action of interest 274 that was selected. The user 300 may then have a better understanding of the decision they were presented with and the possible effects on the country. In another exemplary embodiment, the method may include artificial intelligence 250. The artificial intelligence 250 may suggest other actions related to the action of interest 273 entered by the user 300. The graphical user interface 231 may then display a separate results index 220 for the user 300 generated action of interest 273 and the actions presented by artificial intelligence 273. The user 300 may then be better informed of a variety of options and projected outcomes.

Turning back now to exemplary FIGS. 1 and 2, FIG. 1 displays an exemplary embodiment of a method for evaluating, exploring, and predicting the status of regions of the planet through time, while FIG. 2 shows an exemplary embodiment incorporating artificial intelligences to identify and select the actions of interest, select factors of interest, and select the alerts of interest.

Using a graphical user interface 231, the user 300 may select one or more selections from the selections of interest 270. Artificial intelligence 240 may be used to select the factors of interest 272. Artificial intelligence 250 may be used to identify and/or select the actions of interest 273. Artificial intelligence 260 may be used to select the alerts of interest 274. The artificial intelligences 240, 250, and 260 may factor in previous selections by the user 300 or other users worldwide. The artificial intelligences 240, 250, and 260 may work in conjunction with each other, individually, or any combination therein. The selections of interest 270 may then be used to refine combination 211. Refine combination 211 may then be used to calculate a results index 220 describing the region of interest 271. The results index 220 reflecting the selections may then be represented on the graphical user interface 231. The graphical user interface 231 may show the results index 220 prior to selection of interest 270 along with the results index 220 including selection of interest 270 alongside each other. The graphical user interface 231 may show multiple results index 220 values accounting for various combinations of selections of interest 270.

In an exemplary embodiment, a governor or head-of-state may use the method to help guide their governance of a state or country. The policy-maker may select their country as a region of interest 271. The policy-maker may then set an alert of interest 274 for results index 220 of their region of interest 271. In another embodiment, artificial intelligence 260 may set an alert of interest 274 instead of the policy-maker. An anomalously dry season may then occur. This may threaten habitats, populations, etc. within the region of interest 271. These changes may be measured in the data and produce a new lower results index 220. The graphical user interface 231 may then alert the policy-maker that the results index 220 has dropped. The policy-maker may then decide to act on the change in the results index 220. The policy-maker may wish to put limitations of daytime water use into effect to prevent further issues. The policy-maker may enter the limitation of daytime water use into the graphical user interface 231 as an action of interest 273. The graphical user interface 231 may show a results index 220 based on the entered action of interest 273. The change in the results index 220 may inform the policy-maker of the effectiveness that the action of interest 273 will demonstrate. In other exemplary embodiments, artificial intelligence 250 may suggest actions of interest to the policy-maker based on previous actions taken in response to conditions or changes experienced by other policy-makers in similar situations. In another exemplary embodiment, the policy-maker may not be concerned with some factors that go into the results index 220. The policy maker may choose to eliminate those factors from their results index 220, their alerts of interest 274, and any other use of the platform 200 with respect to region of interest 271.

Turning now specifically to FIGS. 18-25, various exemplary embodiments of a training process may be depicted. Looking first at FIG. 18, FIG. 18 provides a diagram depicting an exemplary embodiment of a training process for an AI system 400. In order to initiate this training process, mapping data 402 may be fed into the AI system, along with labeling information for one or more features provided within the mapping data, which may be created through a human-led labeling process 404. Various exemplary embodiments of a human-led labeling process 404 may be contemplated. For example, in an exemplary embodiment, it may be contemplated for the human-led labeling process 404 to combine information from any or all of: labels applied by an expert or expert group, labels applied by crowdsourcing or a less-skilled workforce, labels applied by an automatic preprocessing system including a deterministic scientific algorithm, a statistical analysis algorithm, or on another machine learning algorithm, and labels applied from another source (such as a map published to the public by another organization). In one such exemplary embodiment, for example, it may be contemplated for a human-led labeling process 404 to begin with a preliminary automated review process intended to label biomes at a high level with some lower level of accuracy, then proceed to a “workforce” review where the automatically-reviewed biomes are reviewed by less-skilled manual reviewers, and then finally end with an expert review process that takes into account the data produced by the other processes. In another exemplary embodiment, the first step may be skipped, and there may be “workforce” review that then moves to “expert” review. In another exemplary embodiment, the human review may identify a category of data on which a deterministic scientific algorithm may be employed to label a known feature (e.g., a specific type of forest or specific type of human infrastructure such as a mining facility or power generation plant).

Based on the mapping data 402 and the labeling process 404, the AI to be trained may engage in AI interpretation 406 of the mapping data 402 in view of the labels applied by the human labeling process 404, which may be performed according to one or more of the machine learning techniques discussed above. As a result of this AI interpretation process 406, the system may be configured to produce a machine-learning model 410 which may be used in order to produce one or more machine maps 408. (For example, in an exemplary embodiment, it may be contemplated for only a small amount of a larger map to be reviewed by a workforce review process or an expert review process, or any other process part of the human-led labeling process 404, in order to train the model via the AI interpretation process 406. Once the machine learning model 410 is completed, the entirety of the larger map may be reviewed by the machine learning model 410, producing a machine map 408.)

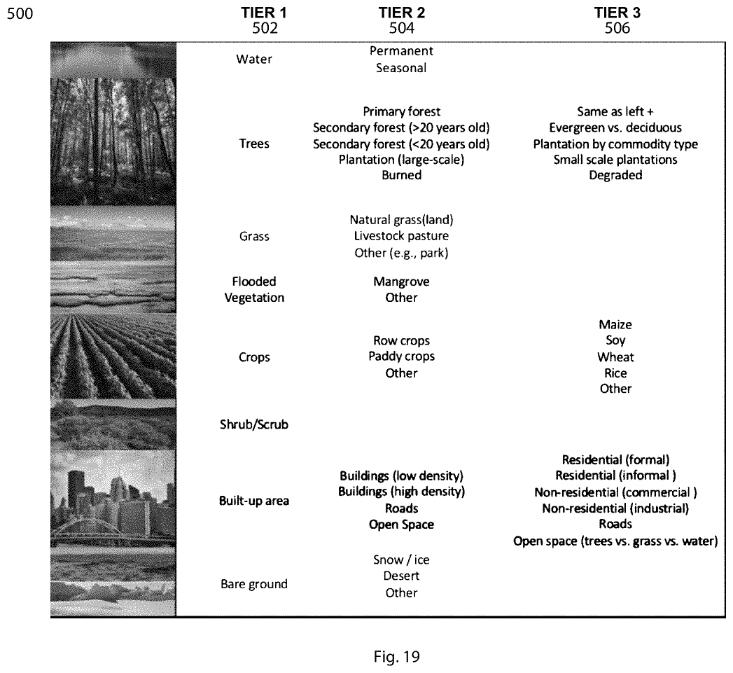

Looking now at FIG. 19, FIG. 19 provides an exemplary hierarchical taxonomy 500 for land use and land cover which may be employed in an exemplary embodiment of a training process. (In this case, the exemplary hierarchical taxonomy 500 provided herein may be that developed for the WORLD RESOURCES INSTITUTE DYNAMIC WORLD project, but other such configurations of a hierarchical taxonomy may of course be compatible with the system, and it may likewise be contemplated for different instances of the system to make use of different taxonomies according to preferences and requirements.) According to an exemplary embodiment, it may be contemplated for a human-led labeling process 404 to begin at a first tier of the taxonomy 502, classifying particular biome images as being one of the entries in the first tier 502 (for example, “water,” “trees,” “grass,” “flooded vegetation,” and the like) and then conducting further review processes in order to classify the biome images more specifically (e.g. as “permanent” or “seasonal” water, or “primary” and “secondary” forest, as tier 2 504 of the taxonomy 500, or as “evergreen forest” versus “deciduous forest” as tier 3 506 of the taxonomy 500). In an exemplary embodiment, different tiers of the taxonomy may correspond to different stages of review; for example, in an exemplary embodiment, an initial automated review process may classify biomes based on the first tier 502, a workforce review process or deterministic scientific algorithm or statistical algorithm may classify biomes based on the second tier 504, and an expert review process may classify biomes based on the third tier 506. (In other exemplary embodiments, this may not be the case; for example, in an alternative exemplary embodiment, a workforce review process and an expert review process may each attempt to classify biomes based on all three tiers.)

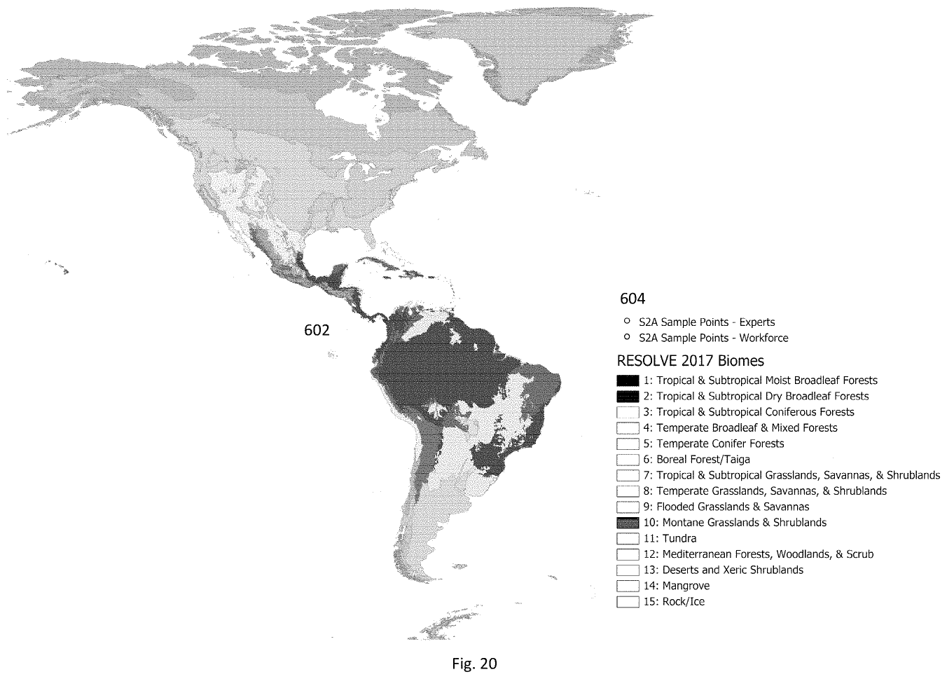

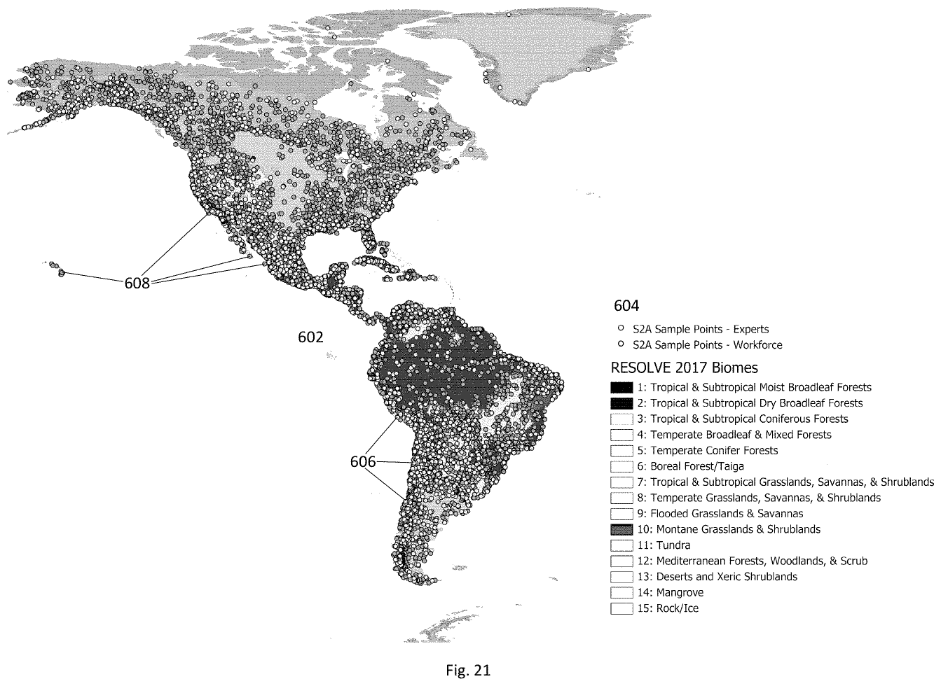

Looking next at FIGS. 20 and 21, FIG. 20 is an exemplary embodiment of a map 602 depicting a sample set of biomes 604, and FIG. 21 is an exemplary embodiment of the same map 602 depicting the same sample set of biomes 604, in this case showing a plurality of exemplary sample points that have been added via an expert review process 606 and via a workforce review process 608. (In this case, it is noted that the fourteen biomes appearing in the exemplary embodiment of the map 602 are those used as part of the Biomes and Ecoregions Interactive Map, created by RESOLVE.)

In an exemplary embodiment, it may be contemplated for the system to provide sample points for review to a team of experts 606 or to a broader workforce 608, in some combination. For example, in one variant, it may be contemplated for the “workforce” data to represent a combination of crowdsourced data and local teams who may be more familiar with those areas, such as is shown in the present map (with the “workforce” data points mostly representing populated cities, like the Mexican cities of Cabo San Lucas and Puerto Vallarta indicated by labels 608) while areas with less representation may need to be supplemented by greater expert review (in this case, rural Mexico's data is almost all expert data, as is the data for the mountain areas depicted by the figure labels 606). As such, it may be contemplated for the system to identify areas that have been under-reviewed by the workforce and which do not have a certain threshold of data points, and automatically request further review of certain areas, if desired.

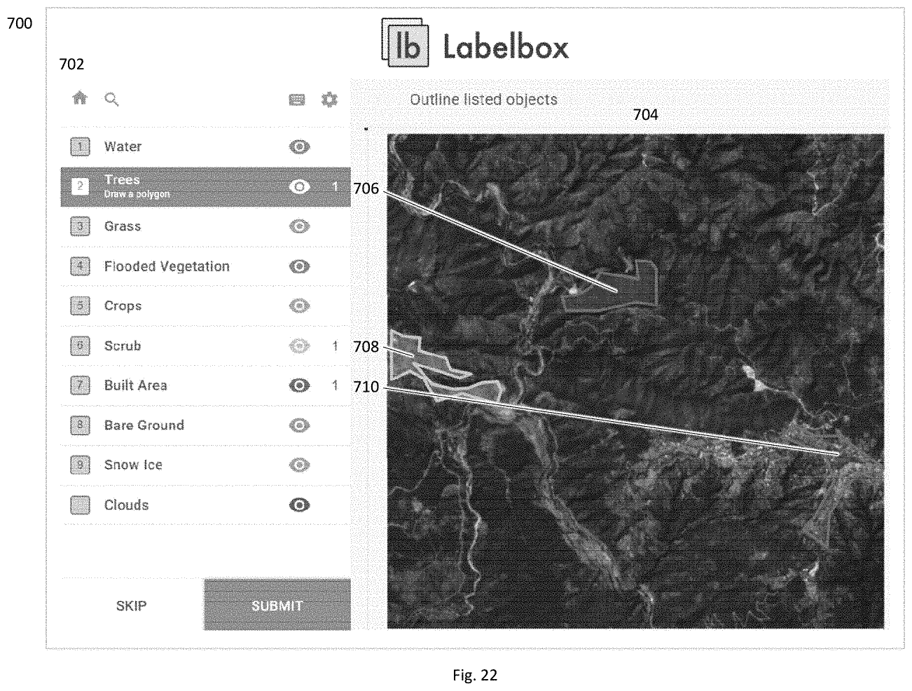

Looking next at FIG. 22, FIG. 22 is an exemplary embodiment of a map depicting an exemplary interface 700 for annotating training data. In an exemplary embodiment of the interface, raw training data may be provided in a map window 704, and the reviewing user may further be provided with a toolset 702 that they may use in order to annotate training data provided in the map window 704. (In this case, it is contemplated to use the LABELBOX mark-up user interface 700 in order to facilitate the annotation of training data for the system, but other variations of this interface can of course be contemplated, which may be used by all reviewing users or by particular sets of reviewing users.) In an exemplary embodiment, a hierarchical taxonomy such as that provided in FIG. 19 may be used. For example, in the provided example, the user may have annotated a first area as being formed from or including “trees” 706, a second area as being formed from or including “scrub” 708, and a third area as being formed from or including “built area” 710. Further areas in the map may then be labeled as the review process is completed. (In one exemplary embodiment, an expert reviewer may then be able to add further labels from further down the hierarchical taxonomy shown in FIG. 19, if desired; for example, the “built-up area” 710 may be separated into high-density buildings and low-density buildings, roads, and so forth. It may alternatively be contemplated for another “workforce” reviewer to conduct secondary review of this level of the mapping data, if desired. These may also be swapped around in any order; for example, it may be contemplated for “workforce” review to be performed at all levels, with “expert” review being used to sample and validate the work product of the “workforce.” That is, if the output of the “workforce” in one region meshes with the output of the expert's review process, then the output of those members of the workforce is more likely to be valid generally.)

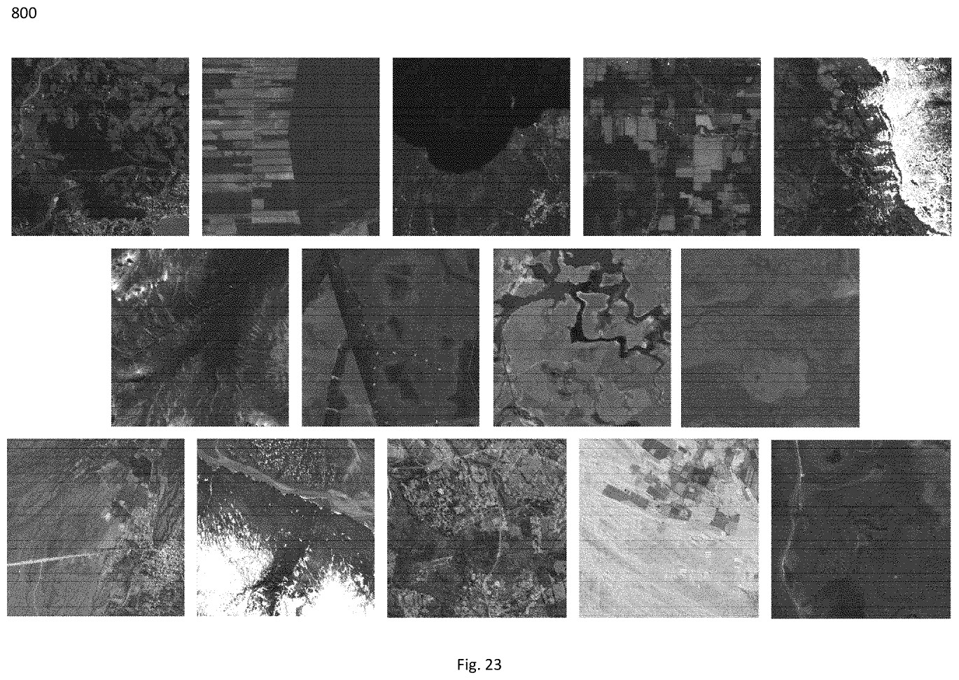

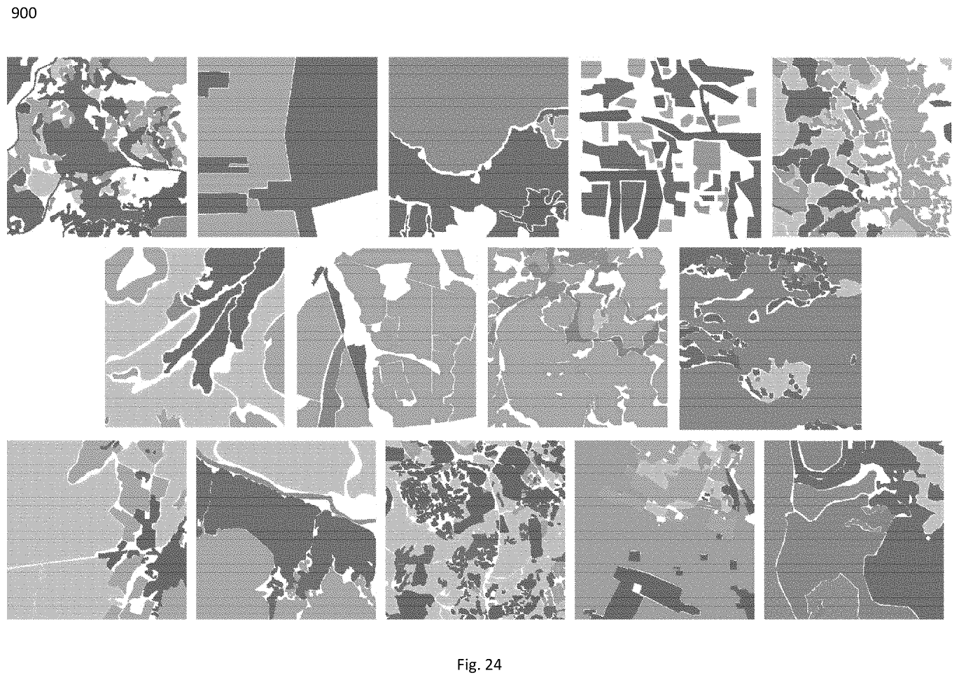

Looking next at FIGS. 23 and 24, FIG. 23 is an exemplary embodiment of a set of biome images 800 taken directly from mapping data. In the provided embodiment, each of these images may correspond to one or more of the biomes discussed earlier (such as those shown in the maps of FIGS. 20 and 21). Each of these biomes may then be fully annotated by human markup as part of the review process, as shown in FIG. 24.

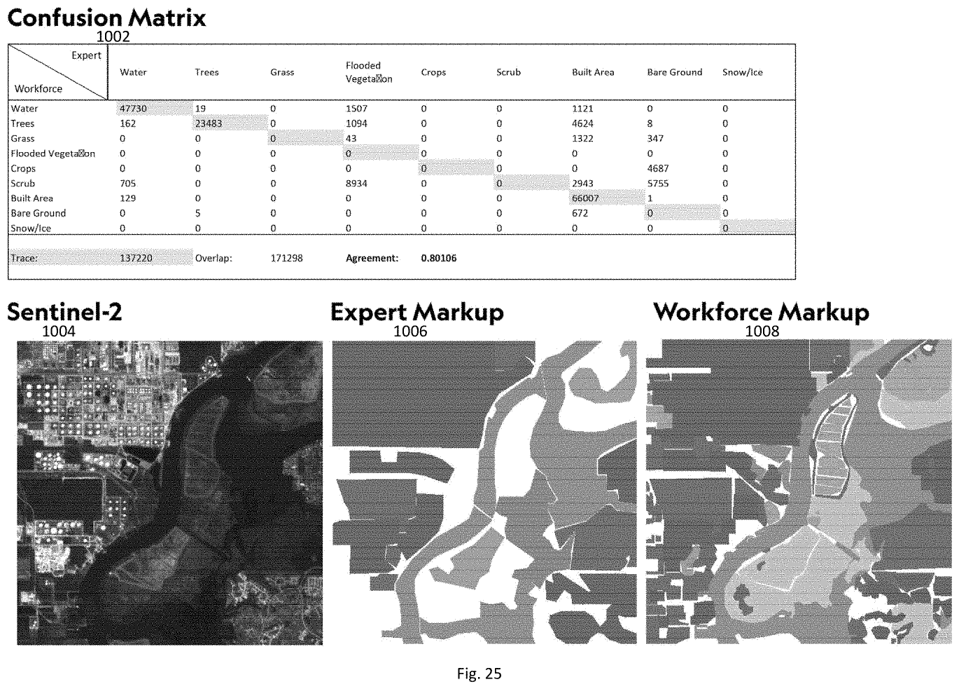

Looking finally at FIG. 25, FIG. 25 is an exemplary diagram presenting a comparison between exemplary embodiments of mapping data 1004 (such as mapping data collected by a satellite like the SENTINEL-2 Earth Observation Mission, as is provided in the exemplary embodiment, though any types of sensed data such as satellite data or aerial photography may be used, alone or in combination), mapping data reviewed by an expert markup process 1006, and mapping data reviewed by a workforce markup process 1008. In the exemplary diagram shown in FIG. 25, the output of the workforce may be validated through use of a “confusion matrix” 1002. In order to construct this matrix, the maps annotated by one or more experts performing the expert markup process 1006 may be compared to the maps annotated by the workforce as part of the workforce markup process 1008, and the degree of agreement between the two may be determined based on the number of regions that are found to be the same and the number of regions that are found to be different. For example, in this case, the expert may have labeled 48726 areas as “water” that were also labeled by the workforce. In this case, the workforce may have agreed with the expert's determination in 47730 out of 48726 cases, and may have disagreed with the expert in a smaller number of cases, describing 162 of the expert's “water” areas as being “trees,” 705 of the expert's “water” areas as being “scrub,” and so forth. This may give the maps an overall agreement score of 0.80106 (based in this case on the number of areas in agreement, 137220, divided by the number of total areas that overlap, 171298), which may be compared to an arbitrary threshold when determining whether to validate the maps or to send the maps back to the experts for further review (or to the workforce for further work).

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for conducting environmental analysis for a region of interest, comprising:
(a) collecting a plurality of datasets, each collected dataset in the plurality of datasets containing a plurality of environmental factors, each environmental factor in the plurality of environmental factors associated with a geospatial position and a reference time;
(b) processing the collected datasets with a first machine-learning algorithm, and generating, from the collected datasets, a dynamic dataset, wherein the first machine-learning algorithm is configured to, according to a mapping model, decompose each collected dataset into a collection of geospatial data points and to associate each geospatial data point with a time identifier and at least one data identifier recognized by the dynamic dataset, and is further configured to determine if there is at least one magnitude associated with each data identifier and, when said at least one magnitude exists, associate said at least one magnitude with the geospatial data point;
(c) selecting the region of interest, said region of interest comprising a plurality of geospatial data points;
(d) selecting at least one factor of interest, wherein the factor of interest is associated with at least one of the data identifiers recognized by the dynamic dataset and any associated magnitudes;
(e) specifying at least one target and/or at least one threshold;
(f) producing an evaluation index for the region of interest, wherein the evaluation index is determined from the selected factor(s) of interest and the specified target(s) and/or threshold(s); and
(g) generating a visualization of the evaluation index for the region of interest.

2. The method of claim 1, further comprising training the first machine-learning algorithm to compile the collected datasets into the dynamic dataset, wherein training the first machine-learning algorithm to compile the collected datasets into the dynamic dataset comprises:
(h) generating at least one first training set, each first training set comprising at least one matched pair of:
a sample source dataset containing environmental factors associated with geospatial positions and reference times, and
a sample decomposition dataset containing a correct decomposition of the sample source dataset into a sample collection of geospatial data points associated with a time identifier and at least one data identifier recognized by the dynamic dataset;
(i) refining the mapping model of the first machine-learning algorithm on the basis of a first accuracy metric and the at least one first training set, wherein the mapping model is provided with at least one sample source dataset and the first accuracy metric is determined from a difference between a model-generated decomposition dataset and the sample decomposition dataset; and
(j) accepting the mapping model when the first accuracy metric reaches a first accuracy threshold.

3. The method of claim 1, wherein specifying at least one target and/or at least one threshold comprises at least one of:
querying a user;
determining, on the basis of the user's usage history, a most commonly requested target(s) and/or threshold(s) in the user's usage history;
determining, on the basis of multiple users' usage history, the most commonly requested target(s) and/or threshold(s) in the multiple users' usage history; and
determining, on the basis of a statistical analysis of data constituting the factor of interest, the target(s) and/or threshold(s).

4. The method of claim 1, wherein producing an evaluation index for the region of interest further comprises compensating for at least one geospatial data point having insufficient data, wherein compensating for the at least one geospatial data point having insufficient data comprises:
identifying the at least one geospatial data point having insufficient data, said at least one geospatial data point having insufficient data comprising at least one data point contained within the region of interest that is not provided with sufficient data to directly support the selected factor(s) of interest; and
processing the dynamic dataset with a second machine-learning algorithm, according to an interpolative model, to generate data for the at least one geospatial data point having insufficient data that corresponds to the selected factor(s) of interest.

5. The method of claim 4, wherein compensating for the at least one geospatial data point having insufficient data further comprises training the second machine-learning algorithm to compensate for the at least one geospatial data point having insufficient data, comprising:
(k) generating at least one second training set, each second training set comprising at least one matched pair of:
a sample complete dataset containing at least one geospatial data point, and
a sample incomplete dataset identical to the sample incomplete dataset except for removal of certain known information;
(l) refining the interpolative model of the second machine-learning algorithm on the basis of a second accuracy metric and the at least one second training set, wherein the interpolative model is provided with at least one sample incomplete dataset and the second accuracy metric is determined from a difference between a model-generated geospatial data point and the sample complete dataset; and
(m) accepting the interpolative model when the second accuracy metric reaches a second accuracy threshold.

6. The method according to claim 5, wherein data removal to form the sample incomplete dataset is biased to be consistent with data commonly missing from collected datasets.

7. The method according to claim 1, wherein an evaluation index is produced for a plurality of reference times to form a time-series evaluation index for the selected region of interest.

8. The method according to claim 7, wherein a third machine-learning algorithm, according to a predictive model, is configured to produce the time-series evaluation index on the basis of at least one arbitrary reference time not associated with any collected dataset.

9. The method according to claim 8, further comprising training the third machine-learning algorithm to compute the evaluation index for an arbitrary reference time, wherein training the third machine-learning algorithm to compute the evaluation index for an arbitrary reference time comprises:
(n) generating at least one third training set, each third training set comprising at least one matched pair of:
a sample initial dataset containing an initial determined evaluation index for a first known time reference and one or more geospatial data points associated with the initial determined evaluation index, and
a sample final dataset containing a final determined evaluation index for a second known time reference and one or more geospatial data points associated with the final determined evaluation index,
(o) refining the predictive model of the third machine-learning algorithm on the basis of a third accuracy metric and the at least one third training set, wherein the predictive model is provided with at least one sample initial dataset and the third accuracy metric is determined from the difference between a model-generated evaluation index at the second known time reference and the sample final dataset; and
(p) accepting the predictive model when the third accuracy metric reaches a third accuracy threshold.

10. The method according to claim 1, wherein the selected region of interest is at least one of:
a region arbitrarily defined by a user via a graphical user interface;
a region corresponding to at least one of the set of: a known national park, a known wildlife refuge, and a known protected natural area;
a region corresponding to at least one of the set of: a city, a state, a nation, a country, and a continent;
a region corresponding to a natural feature; and
a region corresponding to a specified data identifier recognized by the dynamic dataset.

11. The method according to claim 1, wherein multiple regions of interest are selected, and wherein at least one index is produced for each of the multiple regions of interest.

12. The method according to claim 1, further comprising at least one of:
(q) generating an alert when the evaluation index changes or exceeds a specified threshold and/or target; and
(r) reporting a status and/or trend of the region of interest on the basis of the evaluation index.

13. The method according to claim 11, wherein, when the alert is generated, the alert is generated for rapid transmission in multiple communication modalities.

14. A system for conducting environmental analysis for a region of interest, comprising:
a datastore;
at least one processor; and
at least one user interface, wherein:
(a) the datastore is configured to collect a plurality of datasets, each collected dataset in the plurality of datasets containing a plurality of environmental factors, each environmental factor in the plurality of environmental factors associated with a geospatial position and a reference time;
(b) the at least one processor is configured to process the collected datasets stored in the datastore with a first machine-learning algorithm, and generate, from the collected datasets, a dynamic dataset, wherein the first machine-learning algorithm is configured to, according to a mapping model, decompose each collected dataset into a collection of geospatial data points and to associate each geospatial data point with a time identifier and at least one data identifier recognized by the dynamic dataset, and is further configured to determine if there is at least one magnitude associated with each data identifier and, when said at least one magnitude exists, associate said at least one magnitude with the geospatial data point;
(c) the at least one processor is configured to receive, from a user, via the at least one user interface, a selection of the region of interest, wherein the region of interest comprises a plurality of geospatial data points;
(d) the at least one processor is configured to receive, from the user, via the at least one user interface, a selection of at least one factor of interest, wherein the factor of interest is associated with at least one of the data identifiers recognized by the dynamic dataset and any associated magnitudes;
(e) the system for conducting environmental analysis further comprises at least one target and/or threshold, wherein the at least one target and/or threshold is obtained from the user by the at least one user interface or determined on the basis of a usage history or a statistical analysis of data constituting the at least one selected factor of interest;
(f) the at least one processor produces an evaluation index for the region of interest, wherein the evaluation index is determined from the selected factor(s) of interest and the at least one target(s) and/or threshold(s); and
(g) the at least one processor generates a visualization of the evaluation index for the region of interest for display to the user.

15. The system of claim 14, wherein the system is further configured to train the first machine-learning algorithm to compile the collected datasets into the dynamic dataset, wherein training the first machine-learning algorithm to compile the collected datasets into the dynamic dataset comprises:
(h) generating at least one first training set, each first training set comprising at least one matched pair of:
a sample source dataset containing environmental factors associated with geospatial positions and reference times, and
a sample decomposition dataset containing a correct decomposition of the sample source dataset into a sample collection of geospatial data points associated with a time identifier, at least one data identifier recognized by the dynamic dataset;
(i) refining the mapping model of the first machine-learning algorithm on the basis of a first accuracy metric and the at least one first training set, wherein the mapping model is provided with at least one sample source dataset and the first accuracy metric is determined from the difference between a model-generated decomposition dataset and the sample decomposition dataset; and
(j) accepting the mapping model when the first accuracy metric reaches a first accuracy threshold.

16. The system of claim 14, wherein producing an evaluation index for the region of interest further comprises compensating for at least one geospatial data point having insufficient data, wherein compensating for the at least one geospatial data point having insufficient data comprises:
identifying the at least one geospatial data point having insufficient data, said at least one geospatial data point having insufficient data comprising at least one data point contained within the region of interest that is not provided with sufficient data to directly support the selected factor(s) of interest; and
processing the dynamic dataset with a second machine-learning algorithm, according to an interpolative model, to generate data for the at least one geospatial data point having insufficient data that corresponds to the selected factor(s) of interest,
wherein compensating for the at least one geospatial data point having insufficient data further comprises training, with the system, the second machine-learning algorithm to compensate for the at least one geospatial data point having insufficient data, comprising:
(k) generating at least one second training set, each second training set comprising at least one matched pair of:
a sample complete dataset containing at least one geospatial data point, and a sample incomplete dataset identical to the sample incomplete dataset except for removal of certain known information;
(l) refining the interpolative model of the second machine-learning algorithm on the basis of a second accuracy metric and the at least one second training set, wherein the interpolative model is provided with at least one sample incomplete dataset and the second accuracy metric is determined from a difference between a model-generated geospatial data point and the sample complete dataset; and
(m) accepting the interpolative model when the second accuracy metric reaches a second accuracy threshold.

17. The system of claim 14, wherein an evaluation index is produced by the at least one processor for a plurality of reference times to form a time-series evaluation index for the selected region of interest;
wherein a third machine-learning algorithm, according to a predictive model, is configured to produce the time-series evaluation index on the basis of at least one arbitrary reference time not associated with any collected dataset,
wherein the system is further configured to train the third machine-learning algorithm to compute the evaluation index for an arbitrary reference time,
wherein training the third machine-learning algorithm to compute the evaluation index for an arbitrary reference time comprises:
(n) generating at least one third training set, each third training set comprising at least one matched pair of:
a sample initial dataset containing an initial determined evaluation index for a first known time reference and the one or more geospatial data points associated with the initial determined evaluation index,
a sample final dataset containing a final determined evaluation index for a second known time reference and the one or more geospatial data points associated with the final determined evaluation index,
(o) refining the predictive model of the third machine-learning algorithm on the basis of a third accuracy metric and the at least one third training set, wherein the predictive model is provided with at least one sample initial dataset and the third accuracy metric is determined from the difference between a model-generated evaluation index at the second known time reference and the sample final dataset; and
(p) accepting the predictive model when the third accuracy metric reaches a third accuracy threshold.

18. The system according to claim 14, wherein multiple regions of interest are selectable, and the system is further configured to generate at least one comparative result corresponding to the multiple regions of interest.

19. The system according to claim 14, wherein the at least one processor conducts at least one of the following actions:
(q) generating an alert when the evaluation index changes or exceeds a specified threshold and/or target; and
(r) reporting a status and/or trend of the region of interest on the basis of the evaluation index.

20. A system for conducting environmental analysis comprising:
(a) a means for collecting a plurality of datasets, each collected dataset in the plurality of datasets containing a plurality of environmental factors, each environmental factor in the plurality of environmental factors associated with a geospatial position and a reference time;
(b) a means for processing the collected datasets; generating, from the collected datasets, a dynamic dataset; decomposing each collected dataset into a collection of geospatial data points and associating each geospatial data point with a time identifier and at least one data identifier recognized by the dynamic dataset; and determining if there is at least one magnitude associated with each data identifier and, when said at least one magnitude exists, associating said at least one magnitude with the geospatial data point;
(c) a means for selecting a region of interest comprising a plurality of geospatial data points;
(d) a means for selecting at least one factor of interest, wherein the factor of interest is associated with at least one of the data identifiers recognized by the dynamic dataset and any associated magnitudes;
(e) a means for specifying at least one target and/or at least one threshold;
(f) a means for producing an evaluation index for the region of interest, wherein the evaluation index is determined from the selected factor(s) of interest and the specified target(s) and/or threshold(s);
(g) a means for generating a visualization of the evaluation index for the region of interest,
(h) a means for interpreting at least one first training set, each first training set comprising at least one matched pair of:
a sample source dataset containing environmental factors associated with geospatial positions and reference times, and
a sample decomposition dataset containing a correct decomposition of the sample source dataset into a sample collection of geospatial data points associated with a time identifier, at least one data identifier recognized by the dynamic dataset exists;
(i) a means for refining a mapping model on the basis of a first accuracy metric and the at least one first training set, wherein the mapping model is provided with at least one sample source dataset and the first accuracy metric is determined from a difference between a model-generated decomposition dataset and the sample decomposition dataset; and
(j) a means for accepting the mapping model when the first accuracy metric reaches a first accuracy threshold.
